(19) United States
(12) Patent Application Publication
(10) Pub. No.: US 2014/0249762 A1
(43) Pub. Date: Sep. 4, 2014

(54) GENOMIC TENSOR ANALYSIS FOR MEDICAL ASSESSMENT AND PREDICTION

(71) Applicant: UNIVERSITY OF UTAH RESEARCH FOUNDATION, Salt Lake City, UT (US)

(72) Inventor: Orly ALTER, Salt Lake City, UT (US)

(73) Assignee: UNIVERSITY OF UTAH RESEARCH FOUNDATION, Salt Lake City, UT (US)

(21) Appl. No.: 14/201,739

(22) Filed: Mar. 7, 2014

Related U.S. Application Data
(63) Continuation of application No. PCT/US2012/054315, filed on Sep. 7, 2012.
(60) Provisional application No. 61/533,141, filed on Sep. 9, 2011.
(60) Provisional application No. 61/553,840, filed on Oct. 31, 2011.

(51) Int. Cl. G06F 19/00

(52) U.S. Cl. CPC G06F 19/3431
USPC 702/19

(57) ABSTRACT

Systems and methods are described for medical characterization of biological data. One such method includes applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B; where the data comprise indicators, represented in respective rows and columns of the tensor, of values of at least two index parameters; and determining an indicator of a health parameter of a subject, the determining being based on the eigenvectors and on values, associated with the subject, of the at least two index parameters. In some cases, the eigenvectors of A^{T}A are the same as the eigenvectors of B^{T}B.

### CROSS REFERENCE TO RELATED APPLICATIONS

This application is a continuation of International Patent Application No. PCT/US2012/054315, filed Sep. 7, 2012, entitled GENOMIC TENSOR ANALYSIS FOR MEDICAL ASSESSMENT AND PREDICTION, which claims the benefit of U.S. Provisional Application No. 61/533,141, filed Sep. 9, 2011, and U.S. Provisional Application No. 61/553,840, filed Oct. 31, 2011, each of the foregoing applications is incorporated by reference in its entirety.

### GOVERNMENT LICENSE RIGHTS

This invention was made with government support under R01 HG004302 awarded by National Institutes of Health. The government has certain rights in this invention.

### TECHNICAL FIELD

The subject technology relates generally to computational medicine and computational biology.

### BACKGROUND

In many areas of science, especially in biotechnology, the number of high-dimensional datasets recording multiple aspects of a single phenomenon is increasing. This increase is accompanied by a fundamental need for mathematical frameworks that can compare multiple large-scale matrices with different row dimensions. Some of these areas may involve disease prediction based on biological data related to patient and normal samples.

For example, glioblastoma multiforme (GBM), the most common malignant brain tumor in adults, is characterized by poor prognosis. GBM tumors may exhibit a range of copy-number alterations (CNAs), many of which play roles in the cancer's pathogenesis. Large-scale gene expression and DNA methylation profiling efforts have identified GBM molecular subtypes, distinguished by small numbers of biomarkers. However, the best prognostic predictor for GBM remains the patient's age at diagnosis.

Therefore, there is a need for a more effective method for disease related characterization of biological data. The subject technology provides such characterization.

### BRIEF DESCRIPTION OF THE DRAWINGS

FIGS. 1A, 1B, and 1C are high-level diagrams illustrating examples of tensors including biological datasets, according to some embodiments.

FIG. 2 is a high-level diagram illustrating a linear transformation of three-dimensional arrays, according to some embodiments.

FIG. 3 is a block diagram illustrating a biological data characterization system coupled to a database, according to some embodiments.

FIG. 4 is a flowchart of a method for disease related characterization of biological data, according to some embodiments.

FIGS. 5A-5C are diagrams illustrating survival analyses of patients classified GBM-associated chromosome (10, 7, 9p) number changes, according to some embodiments. X-axis: survival time (months); Y-axis: fraction of surviving patients from the initial site. FIG. 5A, line 1: No CNA, N=145, O=110; line 2: Loss, N=102, O=85. FIG. 5B, line 1: No CNA, N=197, O=167; line 2: Gain, N=50, O=36. FIG. 5C, line 1: No CNA, N=219, O=178; line 2: Loss, N=28, O=25.

FIG. 6 is a diagram illustrating genes that are found in chromosomal segment 17:57,851,812-17:57,973,757 of the human genome, according to some embodiments.

FIG. 7 is a diagram illustrating gene that is found in chromosomal segment 7:127,892,509-7:127,947,649 of the human genome, according to some embodiments.

FIG. 8 is a diagram illustrating genes that are found in chromosomal segment 12:33,854-12:264,310 of the human genome, according to some embodiments.

FIG. 9 is a diagram illustrating genes that are found in chromosomal segment 19:33,329,393-19:35-322,055 of the human genome, according to some embodiments.

FIG. 10 is a diagram illustrating survival analyses of an initial set of a number of patients classified by chemotherapy or GSVD and chemotherapy, according to some embodiments. X-axis (all graphs): survival time (months); Y-axis, graphs (a) & (b): Fraction of surviving patients from the initial set; Y-axis, graphs (c) & (d): Fraction of surviving patients from the inclusive confirmation set; Y-axis, graphs (e) & (f): Fraction of surviving patients from the independent validation set. (a) line 1: No, N=49, O=46; line 2: Yes, N=187, O=147. (b) line 1: High/No, N=45, O=42; line 2: High/Yes, N=169, O=135; line 3: Low/No, N=4, O=4; line 4: Low/Yes, N=18, O=12. (c) line 1: No, N=62, O=57; line 2: Yes, N=255, O=188. (d) line 1: High/No, N=58, O=53; line 2: High/Yes, N=233, O=176; line 3: Low/No, N=4, O=4; line 4: Low/Yes, N=22, O=12. (e) line 1: No, N=24, O=22; line 2: Yes, N=130, O=103. (f) line 1: High/No, N=22, O=20; line 2: High/Yes, N=115, O=93; line 3: Low/No, N=2, O=2; line 4: Low/Yes, N=15, O=10.

FIG. 11 is a diagram illustrating a high-order generalized singular value decomposition (HO GSVD) of biological data, according to some embodiments.

FIGS. 12A, 12B, 12C, and 12D are diagrams illustrating a right basis vector of FIG. 4 and mRNA expression oscillations in three organisms, according to some embodiments.

FIGS. 13A, 13B, 13C, 13D, 13E, 13F, 13G, 13H, and 13I are diagrams illustrating an HO GSVD reconstruction and classification of a number of mRNA expressions, according to some embodiments.

FIGS. 14A, 14B, 14C, 14D, 14E, 14F, and 14G are diagrams illustrating simultaneous HO GSVD sequence-independent classification of a number of genes, according to some embodiments.

FIGS. 15A, 15B, and 15C are diagrams illustrating simultaneous correlations among the n=17 arraylets in one organism, according to some embodiments.

FIG. 16 is a diagram illustrating three dimensional least squares approximation of the five-dimensional approximately common HO GSVD subspace, according to some embodiments;

FIGS. 17A, 17B, and 17C are diagrams illustrating an example of S. pombe global mRNA expression reconstructed in the five-dimensional approximately common HO GSVD subspace, according to some embodiments.

FIGS. 18A, 18B, and 18C are diagrams illustrating an example of S. cerevisiae global mRNA expression reconstructed in the five-dimensional approximately common HO GSVD subspace, according to some embodiments.

FIGS. 19A, 19B, and 19C are diagrams illustrating a human global mRNA expression reconstructed in the five-dimensional approximately common HO GSVD subspace, according to some embodiments.

FIGS. 20A, 20B, 20C, 20D, 20E, and 20F are diagrams illustrating significant probelets and corresponding tumor and normal arraylets uncovered by GSVD of the patient-matched GBM and normal blood aCGH profiles, according to some embodiments.

FIGS. 21A, 21B, 21C, 21D, 21E, 21F, 21G, 21H, and 21I are diagrams illustrating survival analyses of three sets of patients classified by GSVD, age at diagnosis or both, according to some embodiments. X-axis (all graphs): survival time (months); Y-axis, graphs (a)-(c): Fraction of surviving patients from the initial set; Y-axis, graphs (d)-(f): Fraction of surviving patients from the inclusive confirmation set; Y-axis, graphs (g)-(i): Fraction of surviving patients from the independent validation set. (a) line 1: High, N=224, O=186; line 2: Low, N=23, O=17. (b) line 1: >50, N=190, O=155; line 2: <50, N=57, O=48. (c) line 1: High/>50, N=183, O=151; line 2: low/<50, N=16, O=13; line 3: High/<50, N=41, O=35; line 4: Low/>50, N=7, O=4. (d) line 1: High, N=307, O=242; line 2: Low, N=27, O=17. (e) line 1: >50, N=254, O=200; line 2: <50, N=80, O=59. (f) line 1: High/>50, N=246, O=195; line 2: low/<50, N=19, O=12; line 3: High/<50, N=61, O=47; line 4: Low/>50, N=8, O=5. (g) line 1: High, N=162, O=136; line 2: Low, N=21, O=14. (h) line 1: >50, N=125, O=107; line 2: <50, N=58, O=43. (i) line 1: High/>50, N=121, O=103; line 2: low/<50, N=17, O=10; line 3: High/<50, N=41, O=33; line 4: Low/>50, N=4, O=4.

FIGS. 22A and 22B are diagrams illustrating most significant probelets in tumor and normal data sets, age at diagnosis or both, according to some embodiments.

FIGS. 23A, 23B, and 23C are diagrams illustrating survival analyses of an initial set of a number of patients classified by GBM-associated chromosome number changes, according to some embodiments.

FIGS. 24A, 24B, 24C, 24D, 24E, 24F, 24G, 24H, 24I, 24J, 24K, 24L are diagrams illustrating survival analyses of an initial set of a number of patients classified by copy number changes in selected segments, according to some embodiments. X-axis (all graphs): survival time (months); Y-axis (all graphs): Fraction of surviving patients from the initial set. (a) line 1: No CNA, N=213, O=176; line 2: Gain, N=34, O=27. (b) line 1: No CNA, N=233, O=190; line 2: Gain, N=8, O=7. (c) line 1: Gain, N=148, O=120; line 2: No CNA, N=98, O=82. (d) line 1: No CNA, N=195, O=166; line 2: Gain, N=52, O=37. (e) line 1: No CNA, N=227, O=192; line 2: Gain, N=19, O=11. (f) line 1: Loss, N=128, O=102; line 2: No CNA, N=118, O=100. (g) line 1: No CNA, N=145, O=120; line 2: Loss, N=102, O=83. (h) line 1: No CNA, N=235, O=193; line 2: Gain, N=9, O=7. (i) line 1: No CNA, N=207, O=170; line 2: Gain, N=39, O=32. (j) line 1: No CNA, N=227, O=186; line 2: Gain, N=19, O=17. (k) line 1: No CNA, N=191, O=167; line 2: Gain, N=56, O=36. (l) line 1: No CNA, N=231, O=191; line 2: Gain, N=14, O=11.

FIG. 25 is a diagram illustrating survival analyses of an initial set of a number of patients classified by a mutation in one of the genes, according to some embodiments;

FIGS. 26A, 26B, and 26C are diagrams illustrating a first most tumor-exclusive probelet and a corresponding tumor arraylet uncovered by GSVD of the patient-matched GBM and normal blood aCGH profiles, according to some embodiments.

FIGS. 27A, 27B, and 27C are diagrams illustrating a normal-exclusive probelet and a corresponding normal arraylet uncovered by GSVD, according to some embodiments.

FIGS. 28A, 28B, and 28C are diagrams illustrating another normal-exclusive probelet and a corresponding normal arraylet uncovered by GSVD, according to some embodiments.

FIGS. 29A, 29B, and 29C are diagrams illustrating yet another normal-exclusive probelet and a corresponding normal arraylet uncovered by GSVD, according to some embodiments.

FIGS. 30A, 30B, and 30C are diagrams illustrating yet another normal-exclusive probelet and corresponding normal arraylet uncovered by GSVD, according to some embodiments.

FIGS. 31A, 31B, and 31C are diagrams illustrating a first most normal-exclusive probelet and corresponding normal arraylet uncovered by GSVD, according to some embodiments.

FIGS. 32A, 32B, 32C, 32D, 32E, 32F are diagrams illustrating differences in copy numbers among the TCGA annotations associated with the significant probelets, according to some embodiments.

FIGS. 33A, 33B, and 33C are diagrams illustrating copy-number distributions of one of the probelet and the corresponding normal arraylet and tumor arraylet, according to some embodiments.

FIG. 34 is a table illustrating proportional hazard models of three sets of patients classified by GSVD, according to some embodiments.

FIG. 35 is a table illustrating enrichment of significant probelets in TCGA annotations, according to some embodiments.

FIG. 36 is a diagram illustrating HO GSVD of biological data related to patient and normal samples, according to some embodiments.

FIG. 37 is a diagram illustrating that the GSVD of two matrices D₁ and D₂ is reformulated as a linear transformation of the two matrices from the two rows x columns spaces to two reduced and diagonalized left basis vectors x right basis vectors spaces, according to some embodiments. The right basis vectors are shared by both datasets. Each right basis vector corresponds to two left basis vectors.

FIG. 38 is a diagram illustrating that the higher-order GSVD (HO GSVD) of three matrices D₁, D₂, and D₃ is a linear transformation of the three matrices from the three rows x columns spaces to three reduced and diagonalized left basis vectors x right basis vectors spaces, according to some embodiments. The right basis vectors are shared by all three datasets. Each right basis vector corresponds to three left basis vectors.

FIG. 39 is a diagram illustrating a higher-order EVD (HOEVD) of the third-order series of the three networks, according to some embodiments.

FIG. 40 is a Table showing the Cox proportional hazard models of the three sets of patients classified by GSVD, chemotherapy or both, according to some embodiments. In each set of patients, the multivariate Cox proportional hazard ratios for GSVD and chemotherapy are similar and do not differ significantly from the corresponding univariate hazard ratios. This means that GSVD and chemotherapy are independent prognostic predictors. The P-values are calculated without adjusting for multiple comparisons.

FIGS. 41A, 41B, and 41C are diagrams illustrating the Kaplan-Meier (KM) survival analyses of only the chemotherapy patients from the three sets classified by GSVD, according to some embodiments.

FIG. 42 is a diagram illustrating the KM survival analysis of only the chemotherapy patients in the initial set, classified by a mutation in IDH1, according to some embodiments.

FIGS. 43A, 43B, 43C, 43D, 43E, 43F, 43G, 43H, 43I, 43J, and 43K are diagrams illustrating the KM survival analyses of only the chemotherapy patients in the initial set of 251 patients classified by copy number changes in selected segments, according to some embodiments. X-axis (all graphs): survival time (months); Y-axis (all graphs): Fraction of surviving chemotherapy patients from the initial set. (a) line 1: No CNA, N=162, O=128; line 2: Gain, N=25, O=19. (b) line 1: No CNA, N=178, O=139; line 2: Gain, N=5, O=4. (c) line 1: Gain N=109, O=85; line 2: No CNA, N=77, O=61. (d) line 1: No CNA, N=149, O=123; line 2: Gain, N=38, O=24. (e) line 1: No CNA, N=171, O=139; line 2: Gain, N=15, O=8. (f) line 1: Loss, N=96, O=74; line 2: No CNA, N=90, O=72. (g) line 1: No CNA, N=110, O=86; line 2: Loss, N=77, O=61. (h) line 1: No CNA, N=176, O=138; line 2: Gain, N=9, O=7. (i) line 1: No CNA, N=160, O=126; line 2: Gain, N=27, O=21. (j) line 1: No CNA, N=171, O=134; line 2: Gain, N=15, O=13. (k) line 1: No CNA, N=144, O=123; line 2: Gain, N=43, O=24. (l) line 1: No CNA, N=174, O=138; line 2: Gain, N=12, O=9.

### SUMMARY

Given increasingly large datasets of biological information associated with disease states, there is a need for an enhanced mathematical framework that can assist in disease related characterization of the datasets including providing effective diagnostic and prognostic predictors and treatment plans.

Some embodiments provide systems, computer readable storage media including instructions, and computer-implemented methods, for disease related characterization of biological data.

Some such methods include the following steps: by a processor, applying a decomposition algorithm to an Nth-order tensor representing data, wherein N≧2, to generate, from at least two submatrices A and B of the tensor, eigenvectors of each of AA^{T}, A^{T}A, BB^{T}, and B^{T}B; wherein the data comprise indicators, represented in at least one of respective rows and columns of the tensor, of values of at least two index parameters; and determining, based on the eigenvectors and on values, associated with a subject, of the at least two index parameters, an indicator of a health parameter of the subject; wherein the health parameter comprises at least one of a differential diagnosis, a first health status of the subject, a disease subtype, at least one of an estimated probability and an estimated risk of a second health status of the subject, an indicator of a prognosis of the subject, or a predicted response to a treatment of the subject.

Optionally, the method further comprises outputting said indicator of health parameter along with a medical assessment, such as an assessment of disease risk (e.g., the subject's probability of developing a disease; the presence or the absence of a disease; the actual or predicted onset, progression, severity, or treatment outcome of a disease, etc.). The medical assessment can be informed to either a physician, or the subject. Optionally, appropriate recommendations can be made (such as a treatment regimen, a preventative treatment regimen, an exercise regimen, a dietary regimen, a life style adjustment etc.) to reduce the risk of developing the disease, or design a treatment regiment that is likely to be effective in treating the disease.

In some embodiments, the index parameters comprise at least two of: patient identifications, tissue type identifications, a health status of one or more patients, a bioactive agent exposure status, an environmental exposure status, a nucleotide sequence copy numbers, DNA sequences, mRNA sequences, mRNA levels, a micro-RNA expression level, a DNA methylation level, a level of binding of proteins to DNA, a level of binding of proteins to RNA, gene product levels, gene product activity levels, a cell cycle status, a biochemical status, imaging data, a treatment status, biomarker levels, or time periods.

In some embodiments, the applying further comprises generating a diagonal matrix of singular values for each of A and B, and wherein the determining is further based on at least one of the diagonal matrices.

In some embodiments, the eigenvectors of A^{T}A are the same as the eigenvectors of B^{T}B.

The subject technology is embodied by at least the following items:

1. A method, for medical characterization of a subject based on biological data, comprising:
applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B;
wherein the data comprise indicators, represented in respective rows and columns of the tensor, of values of at least two index parameters; and
determining an indicator of a health parameter of a subject, the determining based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.

2. The method of item 1, wherein the index parameters comprise at least two of: patient identifications, tissue type identifications, a health status of one or more patients, a bioactive agent exposure status, an environmental exposure status, a nucleotide sequence copy numbers, DNA sequences, mRNA sequences, mRNA levels, a micro-RNA expression level, a DNA methylation level, a level of binding of proteins to DNA, a level of binding of proteins to RNA, gene product levels, gene product activity levels, a cell cycle status, a biochemical status, imaging data, a treatment status, biomarker levels, or time periods.

3. The method of item 1 or 2, wherein the applying further comprises generating a diagonal matrix of singular values of each of A and B, and wherein the determining is further based on at least one of the diagonal matrices, wherein the singular values of A are the square roots of the eigenvalues of A^{T}A.

4. The method of any one of items 1-3, wherein the eigenvectors of A^{T}A are the same as the eigenvectors of B^{T}B.

5. The method of any one of items 1-4, wherein the determining occurs at a first time, and further comprising repeating the determining at a second time to track a course of a health condition of the subject.

6. The method of any one of items 1-5, wherein at least one of the index parameters is measurable by at least one of a DNA microarray, DNA sequencing, a protein microarray, or mass spectrometry.

7. The method of any one of items 1-6, wherein the data comprises chromatin or histone modification, and wherein the data derived from a patient-specific sample including at least one of a normal tissue, a disease-related tissue, or a culture of a patient's cell.

8. The method of any one of items 1-7, wherein the data comprise at least one of magnetic resonance imaging (MRI) data, electrocardiogram (ECG) data, electromyography (EMG) data, or electroencephalogram (EEG) data.

9. The method of any one of items 1-8, wherein the applying substantially removes from the data at least one of normal pattern copy number variations (CNVs) and an experimental variation.

10. The method of any one of items 1-9, wherein the algorithm decomposes the tensor according to at least one of a higher-order singular value decomposition (HOSVD), a higher-order generalized singular value decomposition (HO GSVD), a higher-order eigenvalue decomposition (HOEVD), or a parallel factor analysis (PARAFAC).

11. The method of any one of items 1-10, wherein the applying classifies the subject into a subgroup of patients based on at least patient-specific genomic data.

12. The method of any one of items 1-11, wherein the applying correlates an outcome of a therapeutic method and a genomic predictor in the data.

13. A system, for medical characterization of a subject based on biological data, comprising:
a processor configured to apply a decomposition algorithm to an Nth-order tensor representing data, wherein N≧2, to generate, from at least two submatrices A and B of the tensor, eigenvectors of each of AA^{T}, A^{T}A, BB^{T}, and B^{T}B;
wherein the data comprise indicators, represented in respective rows and columns of the tensor, of values of at least two index parameters; and
an analysis module configured to determine an indicator of a health parameter of a subject, based on the eigenvectors and on values, associated with the subject, of the at least two index parameters;
   wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.

14. The system of item 13, wherein the processor is further configured to generate a diagonal matrix of singular values of each of submatrices A and B, and wherein the analysis module is further configured to determine the indicator of the health parameter based on at least one of the diagonal matrices, wherein the singular values of A are the square roots of the eigenvalues of A^{T}A.

15. The system of item 13 or 14, wherein the analysis module is further configured to determine the indicator of the health parameter at a first time, and to repeat the determination at a second time to track a course of a health condition of the subject.

16. The system of any one of claims 13-15, wherein the processor is further configured to substantially remove from the data at least one of normal pattern copy number variations (CNVs) and an experimental variation.

17. The system of any one of items 13-16, wherein the processor is further configured to apply the decomposition algorithm to decompose the tensor according to at least one of a higher-order singular value decomposition (HOSVD), a higher-order generalized singular value decomposition (HO GSVD), a higher-order eigenvalue decomposition (HOEVD), or a parallel factor analysis (PARAFAC).

18. The system of any one of items 13-17, wherein the processor is further configured to apply the decomposition algorithm to classify the subject into a subgroup of patients based on at least patient-specific genomic data.

19. The system of any one of items 13-18, wherein the processor is further configured to apply the decomposition algorithm to correlate an outcome of a therapeutic method and a genomic predictor in the data.

20. A non-transitory machine-readable medium comprising instructions that, when executed by one or more processors, perform the following acts:
applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B;
wherein the data comprise indicators, represented in respective rows and columns of the tensor, of values of at least two index parameters; and
determining an indicator of a health parameter of a subject, the determining based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.

21. The machine-readable medium of item 20, wherein the applying further comprises generating a diagonal matrix of singular values of each of A and B, and wherein the determining is further based on at least one of the diagonal matrices, wherein the singular values of A are the square roots of the eigenvalues of A^{T}A.

22. The machine-readable medium of item 20 or 21, wherein the applying substantially removes from the data at least one of normal pattern copy number variations (CNVs) and an experimental variation.

23. The machine-readable medium of any one of items 20-22, wherein the algorithm decomposes the tensor according to at least one of a higher-order singular value decomposition (HOSVD), a higher-order generalized singular value decomposition (HO GSVD), a higher-order eigenvalue decomposition (HOEVD), or a parallel factor analysis (PARAFAC).

24. The machine-readable medium of any one of items 20-23, wherein the applying classifies the subject into a subgroup of patients based on at least patient-specific genomic data.

25. The machine-readable medium of any one of items 20-24, wherein the applying correlates an outcome of a therapeutic method and a genomic predictor in the data.

26. A method, for medical characterization of a subject based on biological data, comprising:
(a) applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B;
wherein the data comprise indicators, represented in respective rows and columns of the tensor, of values of at least two index parameters;
(b) determining an indicator of a health parameter of a subject, the determining based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject; and
(c) outputting said indicator of health parameter along with a medical assessment.

### DESCRIPTION OF EMBODIMENTS

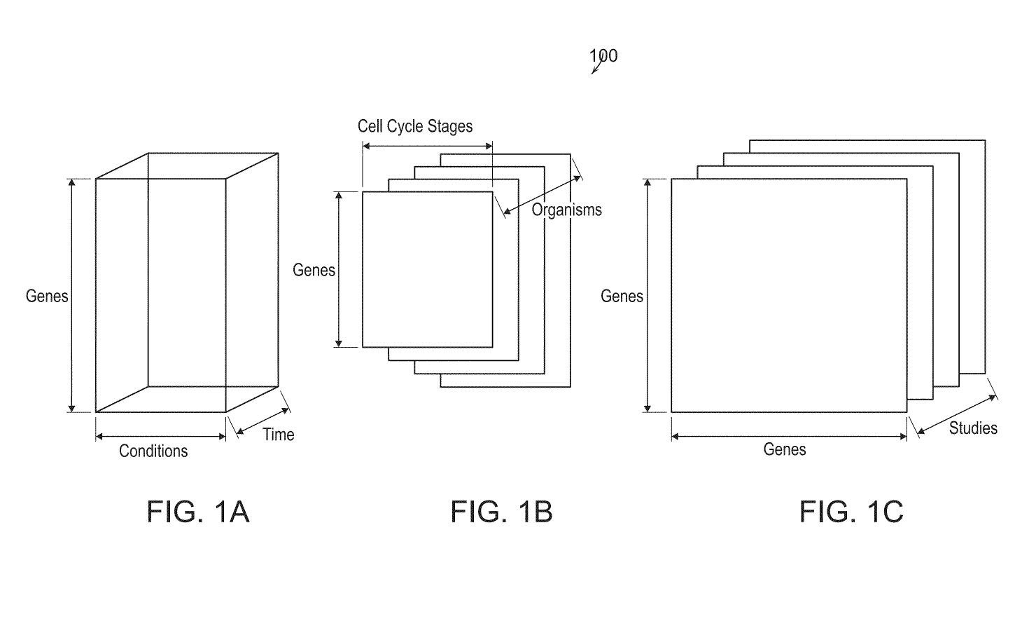

FIG. 1 is a high-level diagram illustrating examples of tensors 100 including biological datasets, according to some embodiments. In general, a tensor representing a number of biological datasets may comprise an Nth-order tensor including a number of multi-dimensional (e.g., two or three dimensional) matrices. The Nth-order tensor may include a number of biological datasets. Some of the biological datasets may correspond to one or more biological samples. Some of the biological dataset may include a number of biological data arrays, some of which may be associated with one or more subjects. Some examples of biological data that may be represented by a tensor includes tensors (a), (b) and (c) shown in FIG. 1. The tensor (a) represents a third order tensor (i.e., a cuboid), in which each dimension (e.g., gene, condition and time) represent a degree of freedom in the cuboid. If unfolded into a matrix, these degrees of freedom may be lost and most of the data included in the tensor may also be lost. However, decomposing the cuboid using a tensor decomposition technique, such as higher-order eigen-value decomposition (HOEVD) or higher-order single value decomposition (HOSVD) may uncover patterns of mRNA expression variations across the genes, the time points and conditions.

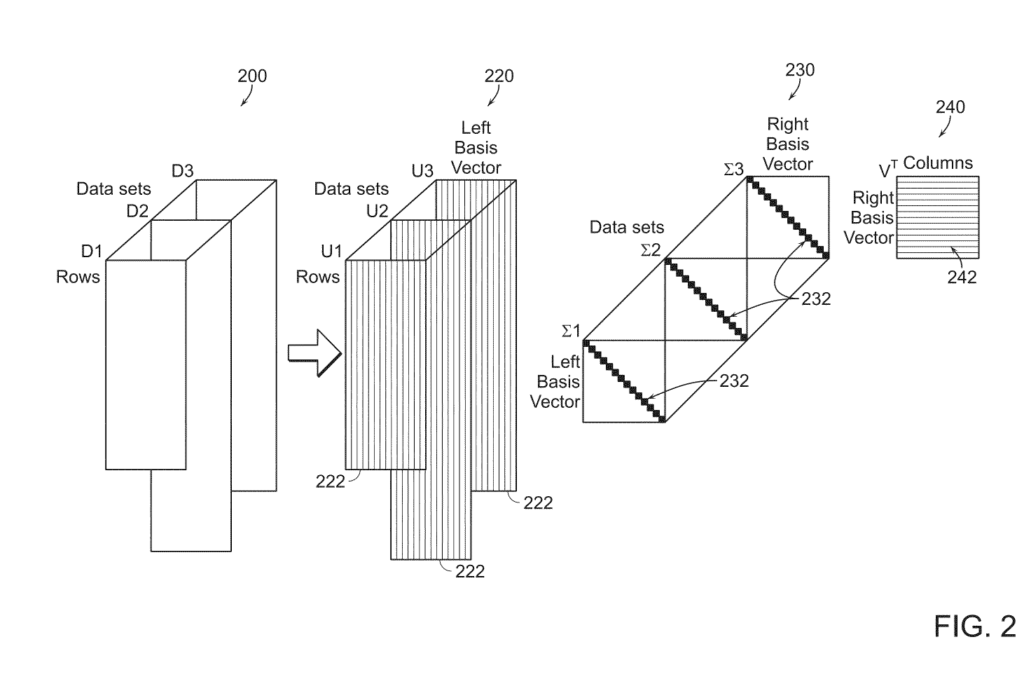

In the example tensor (b) the biological datasets are associated with genes and the one or more subjects comprises organisms and data arrays may include cell cycle stages. The tensor decomposition in this case may allow, for example, integrating global mRNA expressions measured for various organisms, removal of experimental artifacts and identification of significant combinations of patterns of expression variation across the genes, for various organisms and for different cell cycle stages. Similarly, in tensor (c) the biological datasets are associated with a network K of N-genes by N-genes. Where the network K may represent a number of studies on the genes. The tensor decomposition (e.g., HOEVD) in this case may allow, for example, uncovering important relations among the genes (e.g., pheromone-response-dependent relation or orthogonal cell-cycle-dependent relation). An example of a tensor represented by a three-dimensional array is discussed below with reset to FIG. 2.

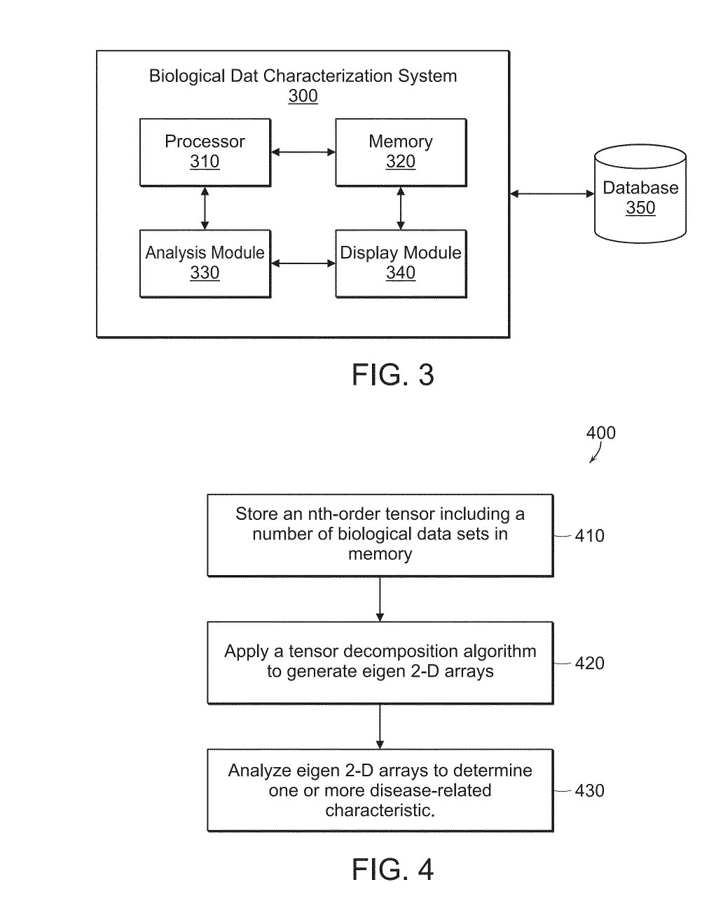

FIG. 2 is a high-level diagram illustrating a linear transformation of a number of two dimensional (2-D) arrays forming a three-dimensional (3-D) array 200, according to some embodiments. The 3-D array 200 may be stored in memory 300 (see FIG. 3). The 3-D array 200 may include a number N of biological datasets that correspond to genetic sequences. In some embodiments, the number N can be greater than two. Each biological dataset may correspond to a tissue type and can include a number M of biological data arrays. Each biological data array may be associated with a patient or, more generally, an organism). Each biological data array may include a plurality of data units (e.g., chromosomes). A linear transformation, such as a tensor decomposition algorithm may be applied to the 3-D array 200 to generate a plurality of eigen 2-D arrays 220, 230 and 240. The generated eigen 2-D arrays 220, 230 and 240 can be analyzed to determine one or more characteristics related to a disease (e.g., changes in glioblastoma multiforme (GBM) tumor with respect to normal tissue). The 3-D array 200 may comprise a number N of 2-D data arrays (D1, D2, D3, . . . DN) (for clarity only D1-D3 are shown in FIG. 2). Each of the 2-D data arrays (D1, D2, D3, . . . DN) can store one set of the biological datasets and includes M columns. Each column can store one of the M biological data arrays corresponding to a subject such as a patient.

As used herein, “health status” may refer to the presence, absence, quality, rank, or severity of any disease or health condition, history and physical examination finding, laboratory value, and the like. As used herein, a “health parameter” can include a differential diagnosis, meaning a diagnosis that is potential, confirmed, unconfirmed, based on a likelihood, ranked, or the like.

In some embodiments, each biological data array may comprise biological data measurable by a DNA microarray (e.g., genomic DNA copy numbers, genome-wide mRNA expressions, binding of proteins to DNA and binding of proteins to RNA), a sequencing technology (e.g., using a different technology that covers the same ground as microarrays), a protein microarray or mass spectrometry, where protein abundance levels are measured on a large proteomic scale and a traditional measurement (e.g., immunohistochemical staining) The biological data may include chromatin or histone modification, a DNA copy number, an mRNA expression, a micro-RNA expression, a DNA methylation, binding of proteins to DNA, binding of proteins to RNA or protein abundance levels.

In some embodiments, the biological data may be derived from a patient-specific sample including a normal tissue, a disease-related tissue or a culture of a patient's cell. The biological datasets may also be associated with genes and the one or more subjects comprises at least one of time points or conditions. The tensor decomposition of the Nth-order tensor may allow for identifying abnormal patterns to identify genes or proteins which enable including or excluding a diagnosis. Further, the tensor decomposition may allow classifying a patient into a subgroup of patients based on patient-specific genomic data, resulting in an improved diagnosis by identifying the patient's disease subtype. The tensor decomposition may also be advantageous in patients therapy planning, for example, by allowing patient-specific therapy to be designed based criteria, such as, a correlation between an outcome of a therapeutic method and a global genomic predictor.

In patients disease prognosis, the tensor decomposition may facilitate designing at least one of predicting a patient's survival or a patient's response to a therapeutic method such as chemotherapy. The Nth-order tensor may include a patient's routine examination data, in which case decomposition of the tensor may allow designing of a personalized preventive regimen for a patient based on analyses of the patient's routine examinations data. In some embodiments, the biological datasets may be associated with imaging data including magnetic resonance imaging (MRI) data, electro cardiogram (ECG) data, electromyography (EMG) data or electroencephalogram (EEG) data. The biological datasets may associated with vital statistics or phenotypic data.

In some embodiments, the tensor decomposition of the Nth-order tensor may allow removing normal pattern copy number variations (CNVs) and an experimental variation from a genomic sequence. The tensor decomposition of the Nth-order tensor may permit an improved prognostic prediction of the disease by revealing disease-associated changes in chromosome copy numbers, focal copy number variations (CNVs) nonfocal CNVs and the like. The tensor decomposition of the Nth-order tensor may also allow integrating global mRNA expressions measured in multiple time courses, removal of experimental artifacts and identification of significant combinations of patterns of expression variation across the genes, the time points and the conditions.

In embodiments, applying the tensor decomposition algorithm may comprise applying at least one of a higher-order singular value decomposition (HOSVD), a higher-order generalized singular value decomposition (HO GSVD), a higher-order eigen-value decomposition (HOEVD) or parallel factor analysis (PARAFAC) to the Nth-order tensor. Some of the present embodiments apply HOSVD to decompose the 3-D array 200, as described in more detail herein. The PARAFAC method is known in the art and will not be described with respect to the present embodiments.

The HOSVD generated eigen 2-D arrays may comprise a set of N left-basis 2-D arrays 220. Each of the left-basis arrays 220 (e.g., U1, U2, U3, . . . UN) (for clarity only U1-U3 are shown in FIG. 2) may correspond to a tissue type and can include a number M of columns, each of which stores a left-basis vector 222 associated with a patient. The eigen 2-D arrays 230 comprise a set of N diagonal arrays (Σ1, Σ2, Σ3, . . . ΣN) (for clarity only Σ1-Σ3 are shown in FIG. 2). Each diagonal array (e.g., Σ1, Σ2, Σ3, . . . or ΣN) may correspond to a tissue type and can include a number N of diagonal elements 232. The 2-D array 240 comprises a right-basis array, which can include a number of right-basis vectors 242.

In some embodiments, decomposition of the Nth-order tensor may be employed for disease related characterization such as diagnosing, tracking a clinical course or estimating a prognosis, associated with the disease.

FIG. 3 is a block diagram illustrating a biological data characterization system 300 coupled to a database 350, according to some embodiments. The system 300 includes a processors 310, memory 320, an analysis module 330 and a display module 340. Processor 310 may include one or more processors and may be coupled to memory 320. Memory 320 may comprise volatile memory such as random access memory (RAM) or nonvolatile memory (e.g., read only memory (ROM), flash memory, etc.). Memory 320 may also include machine-readable medium, such as magnetic or optical disks. Memory 320 may retrieve information related to the Nth-order tensors 100 of FIG. 1 or the 3-D array 200 of FIG. 2 from a database 350 coupled to the system 300 and store tensors 100 or the 3-D array 200 along with 2-D eigen-arrays 220, 230 and 240 of FIG. 2. Database 350 may be coupled to system 300 via a network (e.g., Internet, wide area network (WNA), local area network (LNA), etc.). In some embodiments, system 300 may encompass database 350.

Processor 310 can apply a tensor decomposition algorithm, such as HOSVD, HO GSVD or HOEVD to the tensors 100 or 3-D array 200 and generate eigen 2-D arrays 220, 230 and 240. In some embodiments, processor 310 may apply the HOSVD or HO GSVD algorithms to array comparative genomic hybridization (aCGH) data from patient-matched normal and glioblastoma multiforme (GBM) blood samples. Application of HOSVD algorithm may remove one or more normal pattern copy number variations (CNVs) or experimental variations from the aCGH data. The HOSVD algorithm can also reveal GBM-associated changes in at least one of chromosome copy numbers, focal CNVs and unreported CNVs existing in the aCGH data. In some embodiments, processor 310 may apply a decomposition algorithm to an Nth-order tensor representing data (N≧2) to generate, from two or more submatrices A and B of the tensor, eigenvectors of each of AA^{T}, A^{T}A, BB^{T}, and B^{T}B. The data may comprise indicators, represented in respective rows and columns of the tensor, of values of at least two index parameters. Analysis module 330 can perform disease related characterizations as discussed above. For example, analysis module 330 can facilitate various analyses of eigen 2-D arrays 230 of FIG. 2, for example, by assigning each diagonal element 232 of FIG. 2 to an indicator of a significance of a respective element of a right-basis vector 222 of FIG. 2, as described herein in more detail. In some embodiments, Analysis module 330 can determine an indicator of a health parameter of a subject, based on the eigenvectors and on values, associated with the subject, of the two or more index parameters. The display module 240 can display 2-D arrays 220, 230 and 240 and any other graphical or tabulated data resulting from analyses performed by analysis module 330. Display module 330 can display the indicator of the health parameter of the subject in various ways including digital readout, graphical display, or the like. In embodiments, the indicator of the health parameter may be communicated, to a user or a printer device, over a phone line, a computer network, or the like. Display module 330 may comprise software and/or firmware and may use one or more display units such as cathode ray tubes (CRTs) or flat panel displays.

FIG. 4 is a flowchart of a method 400 for genomic prognostic prediction, according to some embodiments. Method 400 includes storing the nth-tensors 100 of FIG. 1 or 3-D array 200 of FIG. 2 in memory 320 of FIG. 3 (410). A tensor decomposition algorithm such as HOSVD, HO GSVD or HOEVD may be applied, by processor 310 of FIG. 3, to the datasets stored in tensors 100 or 3-D array 200 to generate eigen 2-D arrays 220, 230 and 240 of FIG. 2 (420). The generated eigen 2-D arrays 220, 230 and 240 may be analyzed by analysis module 330 to determine one or more disease-related characteristics (430). The HOSVD algorithm is mathematically described herein with respect to N≧2 matrices (i.e., arrays D₁-D_{N}) of 3-D array 200. Each matrix can be a real mᵢ×n matrix. Each matrix is exactly factored as Dᵢ=Uᵢ ΣᵢV^{T}, where V, identical in all factorizations, is obtained from the balanced eigensystem SV=VΛ of the arithmetic mean S of all pairwise quotients AᵢAⱼ⁻¹ of the matrices Aᵢ=Dᵢ^{T} Di, where i is not equal to j, independent of the order of the matrices D. It can be proved that this decomposition extends to higher orders all of the mathematical properties of the GSVD except for column-wise orthogonality of the matrices Ui (e.g., 2-D arrays 220 of FIG. 2).

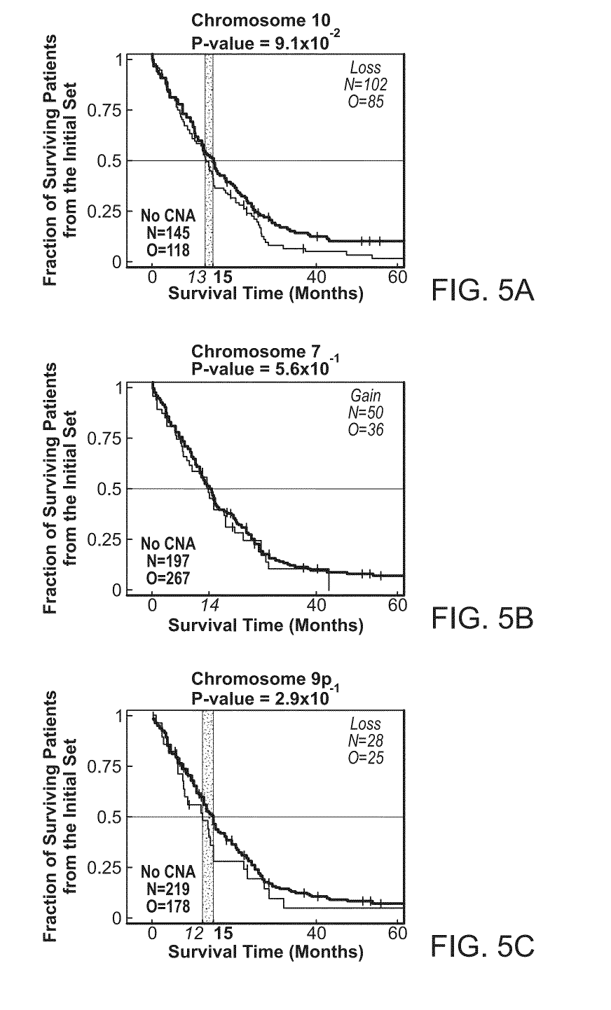

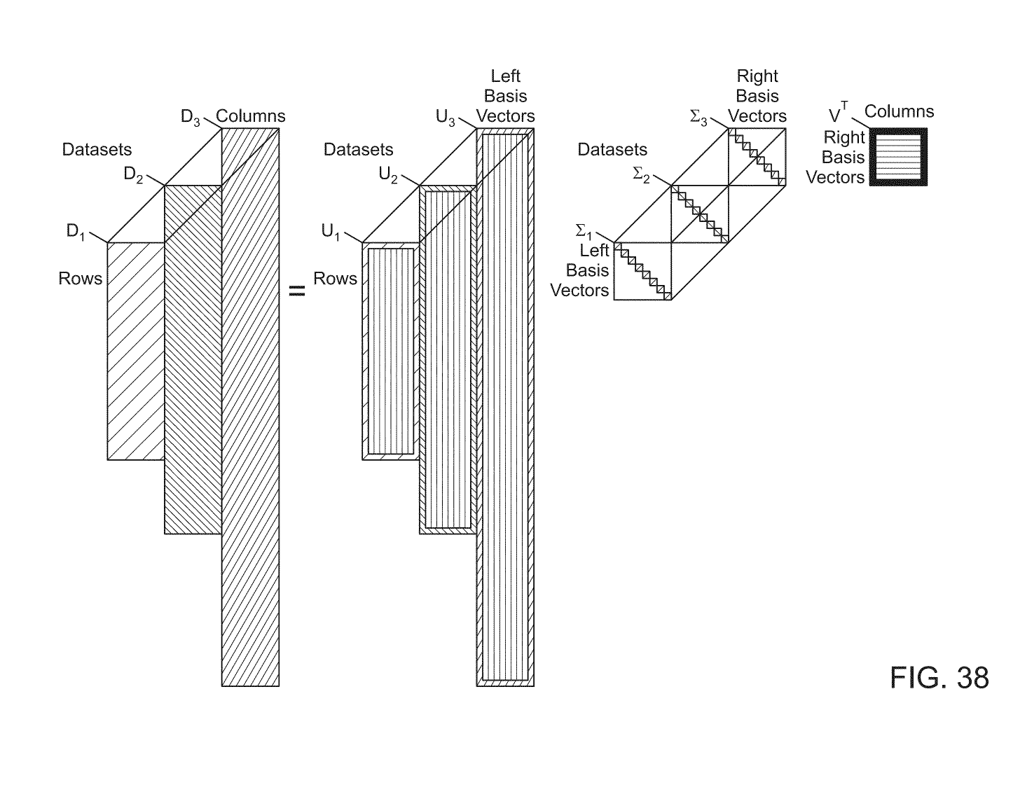

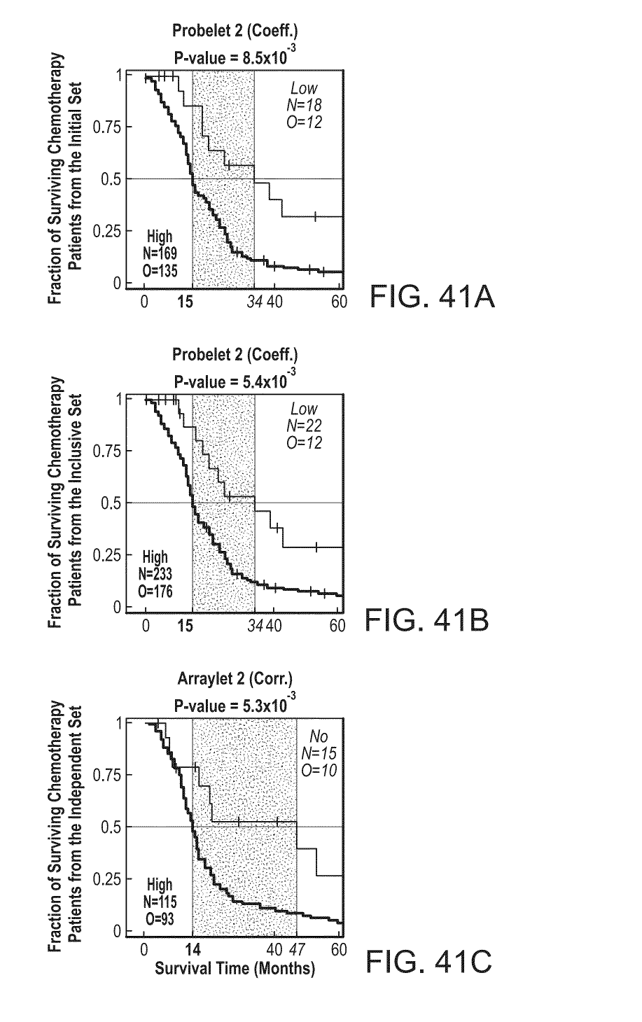

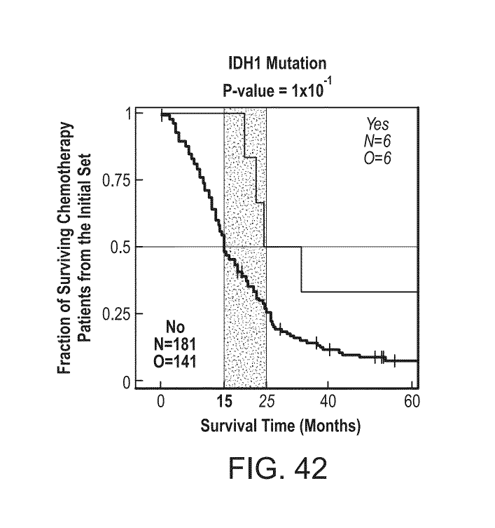

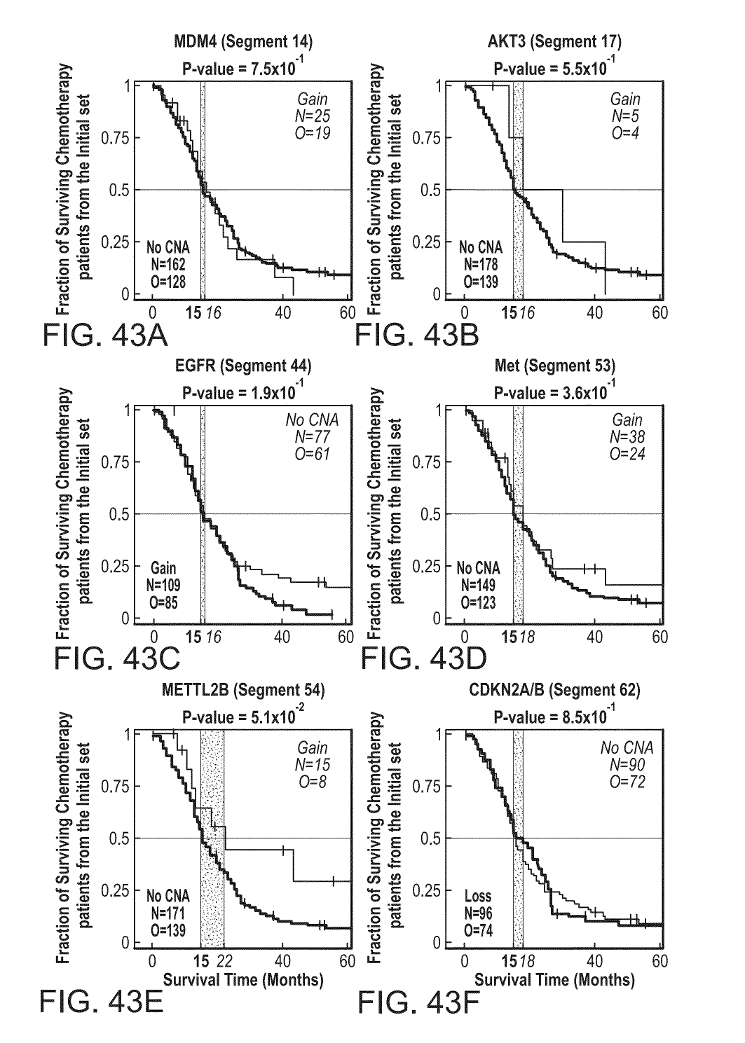

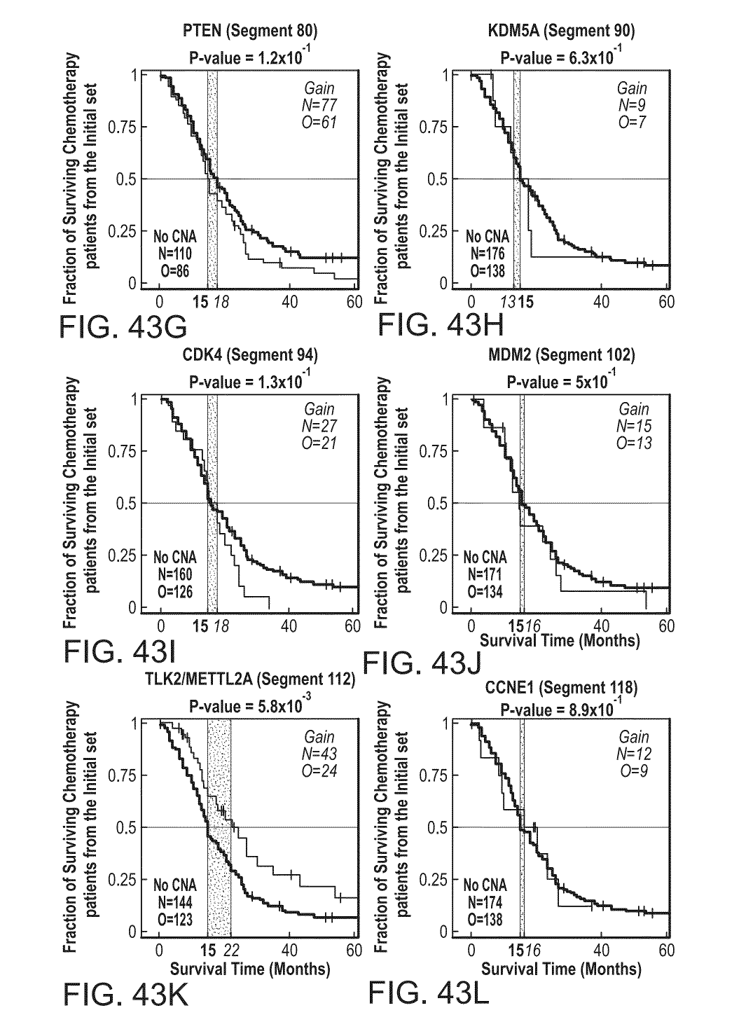

It can be proved that matrix S is nondefective, i.e., S has n independent eigenvectors and that V is real and that the eigenvalues of S (i.e., λ₁, λ₂, . . . λ_{N}) satisfy λₖ≧1. In the described HO GSVD comparison of two matrices, the kₜₕ diagonal element of Σᵢ=diag (σ_{1,k}) (e.g., the kₜₕ element 232 of FIG. 2) is interpreted in the factorization of the iₜₕ matrix Dᵢ as indicating the significance of the kₜₕ right basis vector vₖ in Dᵢ in terms of the overall information that vₖ captures in Dᵢ. The ratio σ_{1,k}/σ_{j,k} indicates the significance of vₖ in Dᵢ relative to its significance in Dⱼ. It can also be proved that an eigenvalue λₖ=1 corresponds to a right basis vector vₖ of equal significance in all matrices Dᵢ and Dⱼ for all i and j, when the corresponding left basis vector u_{i,k} is orthonormal to all other left basis vectors in Uᵢ for all i. Detailed description of various analysis results corresponding to application of the HOSVD to a number of datasets related to patients and other subjects will be discussed with respect to FIGS. 5-43 below. For clarity, more detail treatment of mathematical aspects of HOSVD is skipped here and is provided in documents attached as Appendices A, B, and C. Disclosures in Appendix A have also been published as Lee et al., (2012) GSVD Comparison of Patient-Matched Normal and Tumor aCGH Profiles Reveals Global Copy-Number Alterations Predicting Glioblastoma Multiforme Survival, in PLoS ONE 7(1): e30098. doi:10.1371/journal.pone.0030098. Disclosures in Appendices B and C have been published as Ponnapalli et al., (2011) A Higher-Order Generalized Singular Value Decomposition for Comparison of Global mRNA Expression from Multiple Organisms in PLoS ONE 6(12): e28072. doi:10.1371/journal.pone.0028072.

The HOEVD tensor decomposition method can be used for decomposition of higher order tensors. Herein, as an example, the HOEVD tensor decomposition method is described in relation with a the third-order tensor of size K-networks×N-genes×N-genes as follows:

Higher-Order EVD (HOEVD).

Let the third-order tensor {âₖ} of size K-networks×N-genes×N-genes tabulate a series of K genome-scale networks computed from a series of K genome-scale signals {êₖ}, of size N-genes×Mₖ-arrays each, such that âₖ=êₖê^{T} for all k=1, 2, . . . , K. We define and compute a HOEVD of the tensor of networks {âₖ},

$$\hat{a} ≡ {\sum }_{k = 1}^{K} {\hat{a}}_{k} = \hat{u} ( {\sum }_{k = 1}^{K} {\hat{ɛ}}_{k}^{2} ) {\hat{u}}^{T} = \hat{u} {\hat{ɛ}}^{2} {\hat{u}}^{T} , \qquad [ 5 ]$$

using the SVD of the appended signals ê≡(ê₁, ê₂, . . . , ê_{K})=ûεv^{T}, where the mth column of û, |αₘ [symbol] ≡û|m [symbol] , lists the genome-scale expression of the mth eigenarray of ê. Whereas the matrix EVD is equivalent to the matrix SVD for a symmetric nonnegative matrix, this tensor HOEVD is different from the tensor higher-order SVD (14-16) for the series of symmetric nonnegative matrices {âₖ}, where the higher-order SVD is computed from the SVD of the appended networks (â₁, â₂, . . . , â_{K}) rather than the appended signals. This HOEVD formulates the overall network computed from the appended signals â=êê^{T} as a linear superposition of a series of

$$M ≡ \sum \frac{K}{κ} = 1 {M}_{k}$$

rank-1 symmetric “subnetworks” that are decorrelated of each other, â=Σₘ₌₁^{M}εₘ²|αₘ [symbol] [symbol] αₘ|. Each subnetwork is also decoupled of all other subnetworks in the overall network â, since ε is diagonal.

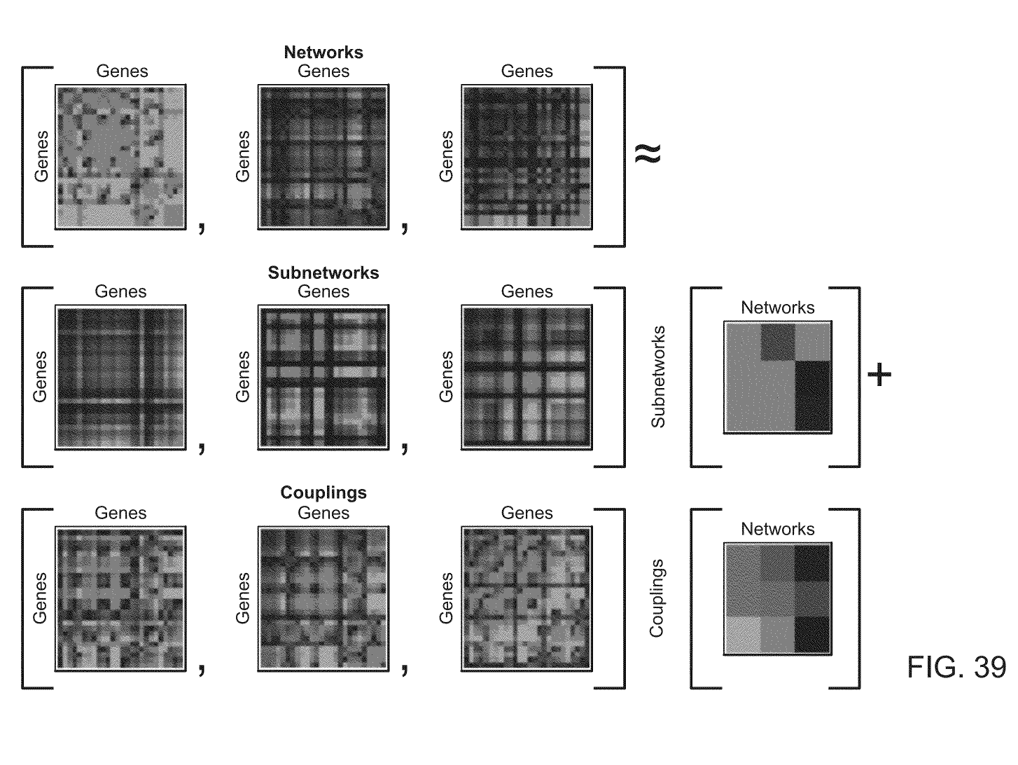

This HOEVD formulates each individual network in the tensor {âₖ} as a linear superposition of this series of M rank-1 symmetric decorrelated subnetworks and the series of M(M−1)/2 rank-2 symmetric couplings among these subnetworks (FIG. 39), such that

$${\hat{a}}_{k} = {\sum }_{m = 1}^{M} {ɛ}_{k , m}^{2} \vert {α}_{m} 〉 〈 {α}_{m} \vert + {\sum }_{m = 1}^{M} {\sum }_{l = m + 1}^{M} {ɛ}_{k , l m}^{2} ( \vert {α}_{l} 〉 〈 {α}_{m} \vert + \vert {α}_{m} 〉 〈 {α}_{l} \vert ) , \qquad [ 6 ]$$

for all k=1, 2, . . . , K. The subnetworks are not decoupled in any one of the networks {âₖ}, since, in general,

$$\{ \hat{ɛ} \frac{2}{k} \}$$

are symmetric but not diagonal, such that ε_{k,m}²≡(l|\hat{ε}ₖ²|m)=(m|\hat{ε}ₖ²|l)≠( ). The significance of the mth subnetwork in the kth network is indicated by the mth fraction of eigenexpression of the kth network p_{k,m}=ε_{k,m}²/(Σₖ₌₁^{K}Σₘ₌₁^{M}ε_{k,m}²)≧0, the expression correlation captured by the mth subnetwork in the kth network relative to that captured by all subnetworks (and all couplings among them, where Σₖ₌₁^{K}ε_{k,m}²=0 for all 1≠m) in all networks. Similarly, the amplitude of the fraction p_{k,lm}=ε_{k,lm}²/(Σₖ₌₁^{K}Σₘ₌₁^{M}ε_{k,m}²) indicates the significance of the coupling between the lth and mth subnetworks in the kth network. The sign of this fraction indicates the direction of the coupling, such that P_{k,lm}>0 corresponds to a transition from the lth to the mth subnetwork and P_{k,lm}<0 corresponds to the transition from the mth to the lth. For real signals {êₖ}, the subnetworks are unique, and the couplings among them are unique up to phase factors of ±1, except in degenerate subspaces of \hat{ε}.

Interpretation of the Subnetworks and their Couplings.

We parallel- and antiparallel-associate each subnetwork or coupling with most likely expression correlations, or none thereof, according to the annotations of the two groups of x pairs of genes each, with largest and smallest levels of correlations in this subnetwork or coupling among all X=N(N−1)/2 pairs of genes, respectively. The P value of a given association by annotation is calculated by using combinatorics and assuming hypergeometric probability distribution of the Y pairs of annotations among the X pairs of genes, and of the subset of y⊂Y pairs of annotations among the subset of x⊂X pairs of genes, P(x;y, Y, X)=(ₓ^{X})⁻¹Σ_{2=y}^{x}(₂^{Y})(ₓ₋₂^{X-Y})⁻, where (ₓ^{X})=X|x!⁻¹(X−x)⁻¹ is the binomial coefficient (17). The most likely association of a subnetwork with a pathway or of a coupling between two subnetworks with a transition between two pathways is that which corresponds to the smallest P value. Independently, we also parallel- and antiparallel-associate each eigenarray with most likely cellular states, or none thereof, assuming hypergeometric distribution of the annotations among the N-genes and the subsets of n⊂N genes with largest and smallest levels of expression in this eigenarray. The corresponding eigengene might be inferred to represent the corresponding biological process from its pattern of expression.

For visualization, we set the x correlations among the X pairs of genes largest in amplitude in each subnetwork and coupling equal to ±1, i.e., correlated or anticorrelated, respectively, according to their signs. The remaining correlations are set equal to 0, i.e., decorrelated. We compare the discretized subnetworks and couplings using Boolean functions (6).

FIG. 39 is a higher-order EVD (HOEVD) of the third-order series of the three networks {â₁, â₂, â₃}. The network â is the pseudoinverse projection of the network â₁ onto a genome-scale proteins' DNA-binding basis signal of 2,476-genes×12-samples of development transcription factors (Mathematica Notebook 3 and Data Set 4), computed for the 1,827 genes at the intersection of â₁ and the basis signal. The HOEVD is computed for the 868 genes at the intersection of â₁, â₂ and â₃. Raster display of aₖ≈Σₘ₌₁³ε_{k,m}²|αₘ [symbol] [symbol] αₘ|+Σₘ₌₁³Σₗ₌ₘ₊₁³ε_{k,m}²(|αₗ [symbol] [symbol] αₘ|+|αₘ [symbol] [symbol] αₗ|), for all k=1, 2, 3, visualizing each of the three networks as an approximate superposition of only the three most significant HOEVD subnetworks and the three couplings among them, in the subset of 26 genes which constitute the 100 correlations in each subnetwork and coupling that are largest in amplitude among the 435 correlations of 30 traditionally-classified cell cycle-regulated genes. This tensor HOEVD is different from the tensor higher-order SVD [14-16] for the series of symmetric nonnegative matrices {â₁, â₂, â₃}. The subnetworks correlate with the genomic pathways that are manifest in the series of networks. The most significant subnetwork correlates with the response to the pheromone. This subnetwork does not contribute to the expression correlations of the cell cycle-projected network â₂, where ε_{2,1}²≈0. The second and third subnetworks correlate with the two pathways of antipodal cell cycle expression oscillations, at the cell cycle stage G₁ vs. those at G₂, and at S vs. M, respectively. These subnetworks do not contribute to the expression correlations of the development-projected network â₃, where ε_{3,2}²≈ε_{3,3}²≈0. The couplings correlate with the transitions among these independent pathways that are manifest in the individual networks only. The coupling between the first and second subnetworks is associated with the transition between the two pathways of response to pheromone and cell cycle expression oscillations at G₁ vs. those G₂, i.e., the exit from pheromone-induced arrest and entry into cell cycle progression. The coupling between the first and third subnetworks is associated with the transition between the response to pheromone and cell cycle expression oscillations at S vs. those at M, i.e., cell cycle expression oscillations at G₁/S vs. those at M. The coupling between the second and third subnetworks is associated with the transition between the orthogonal cell cycle expression oscillations at G₁ vs. those at G₂ and at S vs. M, i.e., cell cycle expression oscillations at the two antipodal cell cycle checkpoints of G₁/S vs. G₂/M. All these couplings add to the expression correlation of the cell cycle-projected â₂, where ε_{2,12}², ε_{2,13}², ε_{2,23}²>0; their contributions to the expression correlations of â₁ and the development-projected â₃ are negligible.

FIGS. 5A-5C show Kaplan-Meier survival analyses of an initial set of 251 patients classified by GBM-associated chromosome number changes. FIG. 5A shows KM survival analysis for 247 patients with TCGA annotations in the initial set of 251 patients, classified by number changes in chromosome 10. This figure shows almost overlapping KM curves with a KM median survival time difference of ˜2 months, and a corresponding log-rank test P-value ˜10⁻¹, meaning that chromosome 10 loss, frequently observed in GBM, is a poor predictor of GBM survival. FIG. 5B shows KM survival analysis for 247 patients classified by number changes in chromosome 7. This figure shows almost overlapping KM curves with a KM median survival time difference of <1 month and a corresponding log-rank test P-value >5×10⁻¹, meaning that chromosome 7 gain is a poor predictor of GBM survival. FIG. 5C is a KM survival analysis for 247 patients classified by number changes in chromosome 9p. This figures shows a KM median survival time difference of ˜3 months, and a log-rank test P-value >10⁻¹, meaning that chromosome 9p loss is a poor predictor of GBM survival.

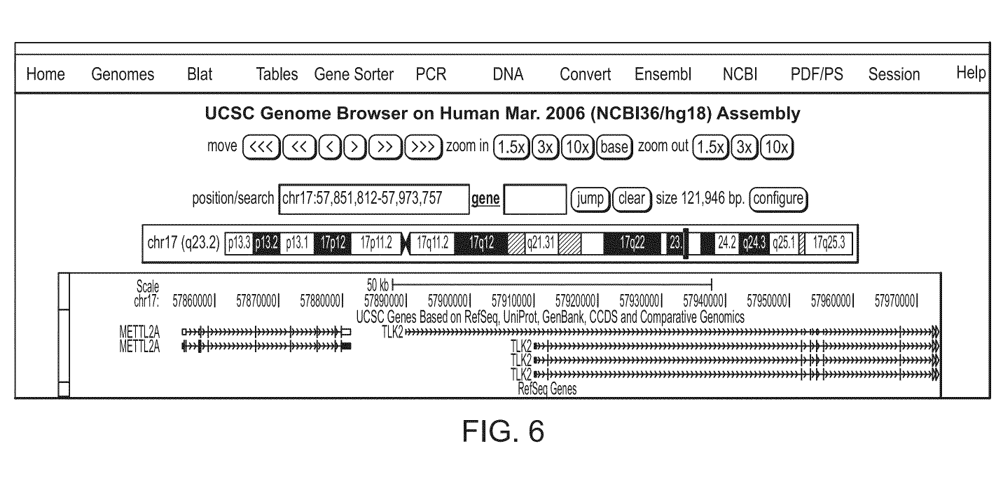

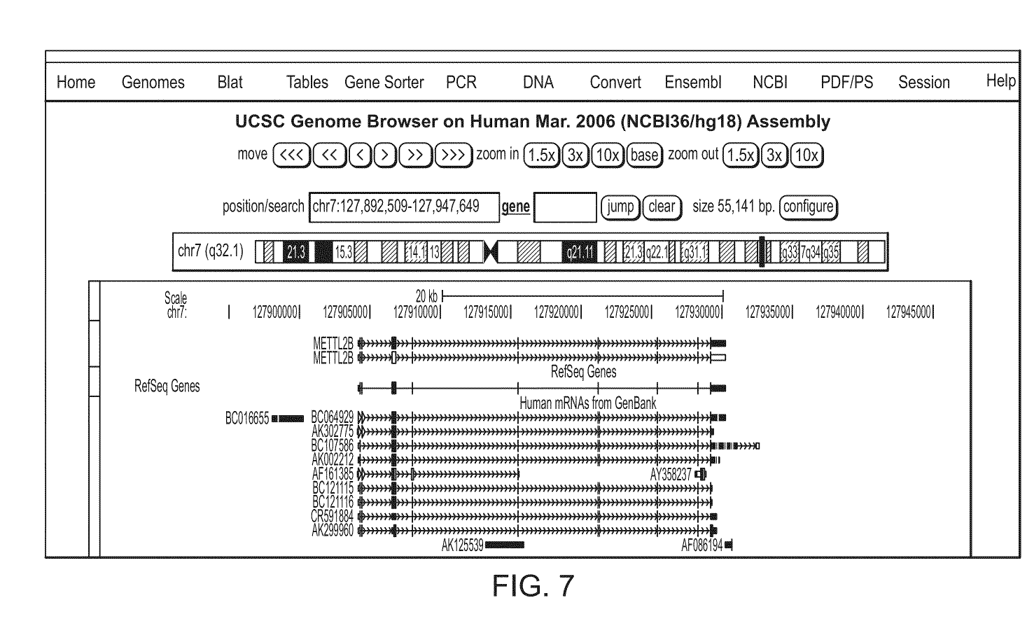

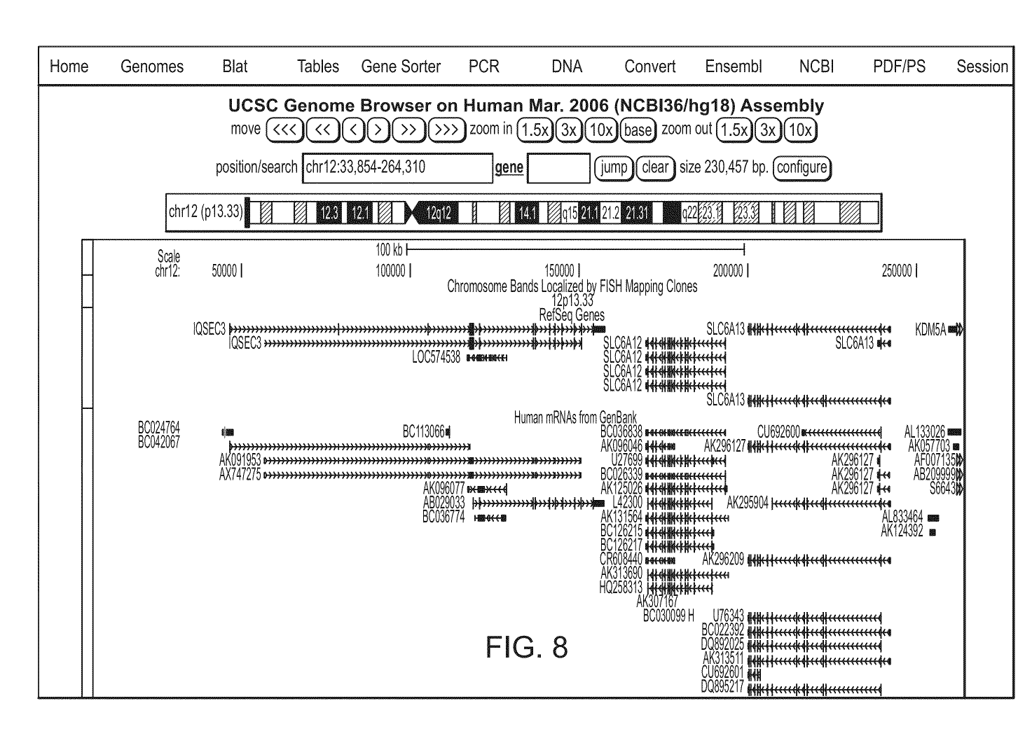

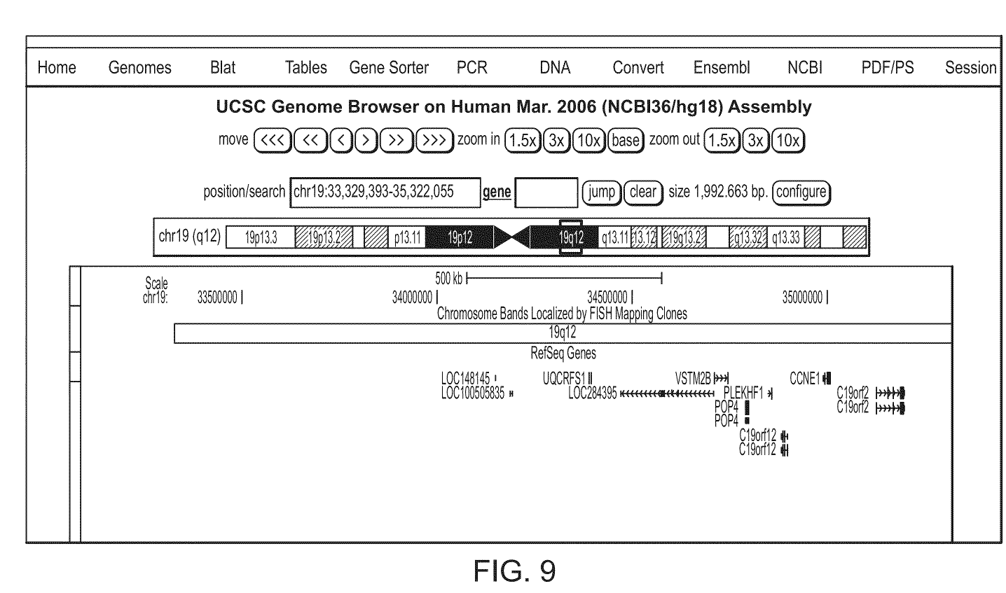

Previously unreported CNAs identified by GSVD include TLK2, METTL2A, METTL2B, KDM5A, SLC6A12, SLC6A13, IQSEC3, CCNE1, POP4, PLEKHF1, C19orf12, and C19orf2. For example, TLK2/METTL2A (17q23.2) is amplified in ˜22% of the patients; METTL2B (7q32.1) is amplified in ˜8% of the patients; and KDM5A (12p13.33) is amplified in ˜4% of the patients. Moreover, these identified genes primarily reside in 4 genetic segments: chr17:57,851,812-chr17:57,973,757 encompassing TLK2 and METTL2A (FIG. 6); chr7:127,892,509-chr7:127,947,649 encompassing METTL2B (FIG. 7); chr12:33,854-chr12:264,310 encompassing KDM5A, SLC6A12, SLC6A13, and IQSEC3 (FIG. 8); and chr19:33,329,393-chr19:35,322,055 encompassing CCNE1, POP4, PLEKHF1, C19orf12, and C19orf2 (FIG. 9).

FIG. 6 is a diagram illustrating genes that are found in chromosomal segment 17:57,851,812-17:57,973,757 of the human genome, according to some embodiments.

FIG. 7 shows a diagram of a genetic map illustrating the coordinates of TLK2 and METTL2A on segment chr17:57,851,812-chr17:57,973,757 on NCBI36/hg18 assembly of the human genome. The amplification of this segment is correlated with GBM prognosis. Copy-number amplification of TLK2 has been correlated with overexpression in several other cancers. Previous studies have shown that the human gene TLK2, with homologs in the plant Arabidopsis thaliana but not in the yeast Saccharomyces cerevisiae, encodes for a multicellular organisms-specific serine/threonine protein kinase, a biochemically putative drug target, whose activity directly depends on ongoing DNA replication.

FIG. 8 shows a diagram of a genetic map illustrating the coordinates of METTL2B on segment chr7:127,892,509-chr7:127,947,649 on NCBI36/hg assembly of the human genome. Previous studies have shown that overexpression of METTL2A/B has been linked to metastatic samples relative to primary prostate tumor samples; cAMP response element-binding (CREB) regulation in myeloid leukemia, and response to chemotherapy in breast cancer patients.

FIG. 9 shows a diagram of a genetic map illustrating the coordinates of CCNE1, POP4, PLEKHF1, C19orf12, and C19orf2 on segment chr19:33,329,393-chr19:35,322,055 on NCBI36/hg assembly of the human genome. Previous studies have shown that CCNE1 regulates entry into the DNA synthesis phase of the cell division cycle and copy number amplification of CCNE1 has been linked with several cancers but not GBM. Recent studies suggest that there is a link between amplicon-dependent expression of CCNE1 together with the flanking genes POP4, PLEKHF1, C19orf12, and C19orf2 on the segment and primary treatment of ovarian cancer may be due to rapid repopulation of the tumor after chemotherapy.

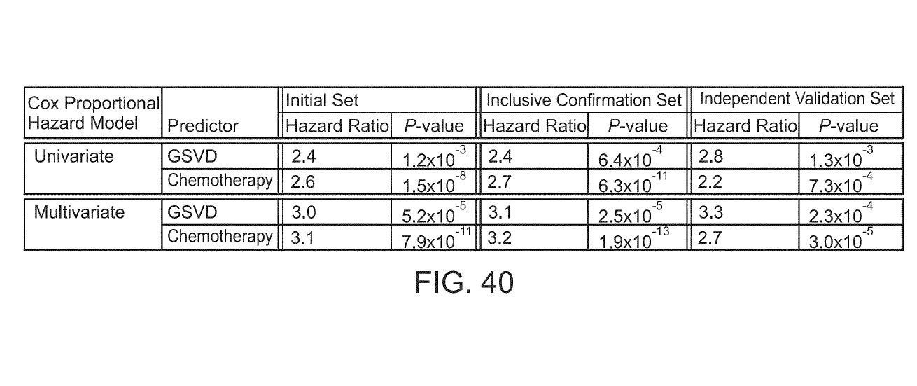

FIG. 10 is a diagram illustrating survival analyses of a set of patients classified by copy number changes in selected segments, according to some embodiments. Survival analyses of the patients from the three sets classified by chemotherapy alone or GSVD and chemotherapy both. (a) KM and Cox survival analyses of the 236 patients with TCGA chemotherapy annotations in the initial set of 251 patients, classified by chemotherapy, show that lack of chemotherapy, with a KM median survival time difference of about 10 months and a univariate hazard ratio of 2.6 (FIG. 40), confers more than twice the hazard of chemotherapy. (b) Survival analyses of the 236 patients classified by both GSVD and chemotherapy, show similar multivariate Cox hazard ratios, of 3 and 3.1, respectively. This means that GSVD and chemotherapy are independent prognostic predictors. With a KM median survival time difference of about 30 months, GSVD and chemotherapy combined make a better predictor than chemotherapy alone. (c) Survival analyses of the 317 patients with TCGA chemotherapy annotations in the inclusive confirmation set of 344 patients, classified by chemotherapy, show a KM median survival time difference of about 11 months and a univariate hazard ratio of 2.7, and confirm the survival analyses of the initial set of 251 patients. (d) Survival analyses of the 317 patients classified by both GSVD and chemotherapy show similar multivariate Cox hazard ratios, of 3.1 and 3.2, and a KM median survival time difference of about 30 months, with the corresponding log-rank test P-value <10⁻¹⁷. This confirms that the prognostic contribution of GSVD is independent of chemotherapy, and that combined with chemotherapy, GSVD makes a better predictor than chemotherapy alone. (e) Survival analyses for the 154 patients with TCGA chemotherapy annotations in the independent validation set of 184 patients, classified by chemotherapy, show a KM median survival time difference of about 11 months and a univariate hazard ratio of 2.2, and validate the survival analyses of the initial set of 251 patients. (f) Survival analyses for the 154 patients classified by both GSVD and chemotherapy, show similar multivariate Cox hazard ratios, of 3.3 and 2.7, and a KM median survival time difference of about 43 months. This validates that the prognostic contribution of GSVD is independent of chemotherapy, and that combined with chemotherapy, GSVD makes a better predictor than chemotherapy alone, also for patients with measured GBM aCGH profiles in the absence of matched normal blood profiles.

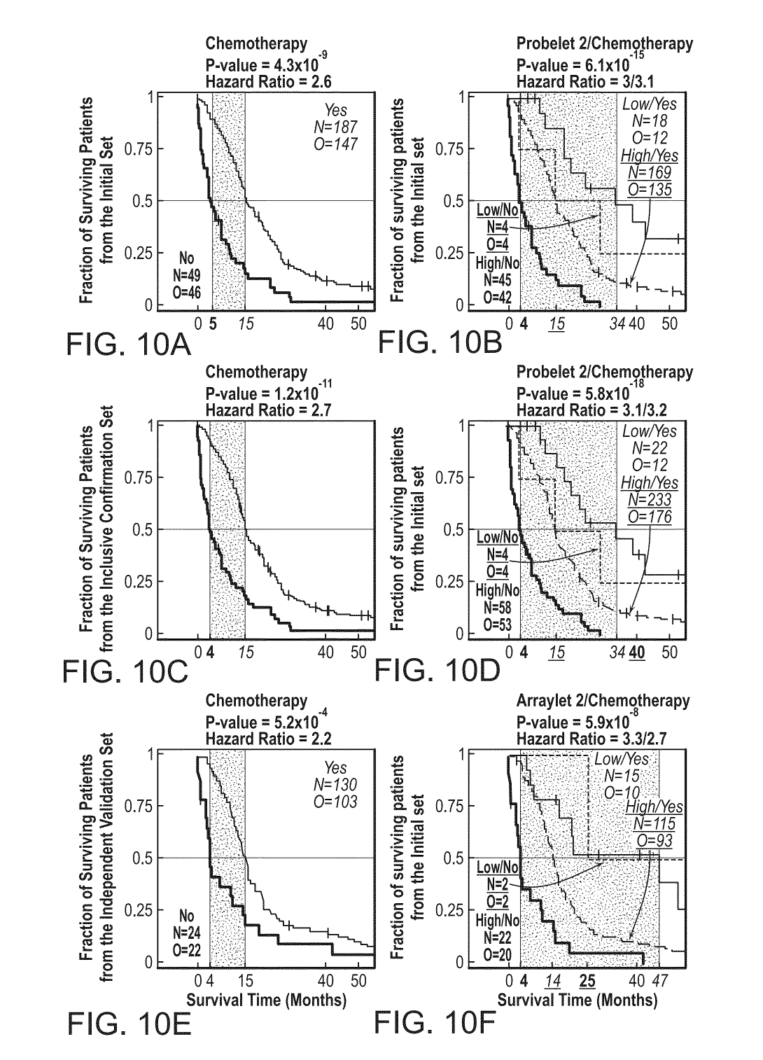

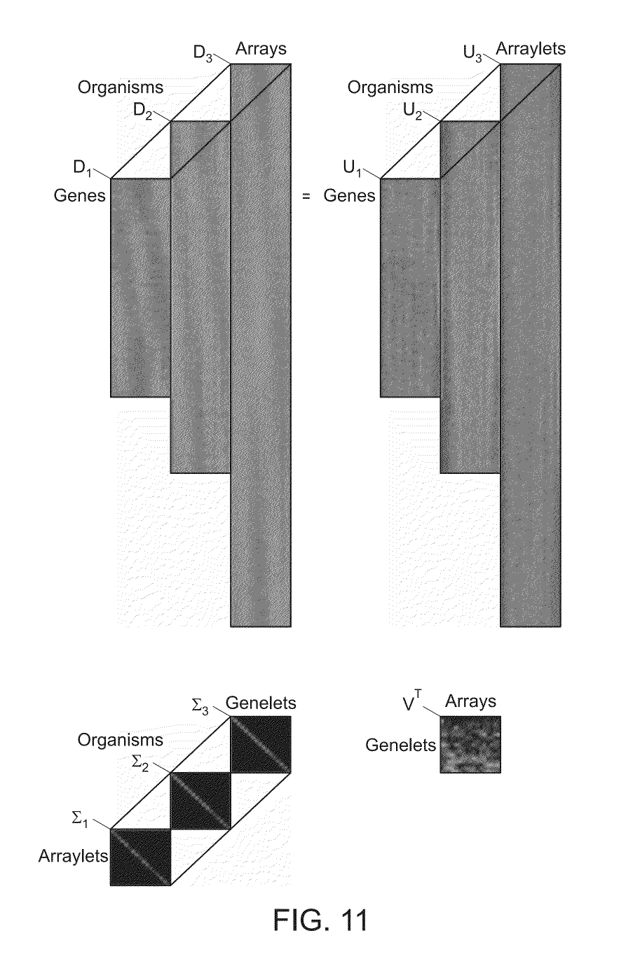

FIG. 11 is a diagram illustrating a HO GSVD of biological data, according to some embodiments. In this raster display, the S. pombe, S. cerevisiae and human global mRNA expression datasets are tabulated as organism-specific genes×17-arrays matrices D₁, D₂ and D₃. Overexpression, no change in expression, and underexpression have been centered at gene- and array-invariant expression. The underlying assumption is that there exists a one-to-one mapping among the 17 columns of the three matrices but not necessarily among their rows. These matrices are transformed to the reduced diagonalized matrices Σ₁, Σ₂ and Σ₃, each of 17-“arraylets,” i.e., left basis vectors×17-“genelets,” i.e., right basis vectors, by using the organism-specific genes×17-arraylets transformation matrices Uₗ, U₂ and U₃ and the shared 17-genelets×17-arrays transformation matrix V^{T}. For this particular V, this decomposition extends to higher orders all of the mathematical properties of the GSVD except for orthogonality of the arraylets, i.e., left basis vectors that form the matrices Uₗ, U₂ and U₃. Thus, the genelets, i.e., right basis vectors vₖ are defined to be of equal significance in all the datasets when the corresponding arraylets u_{1,k}, u_{2,k} and u_{3,k} are orthonormal to all other arraylets in U₁, U₂ and U₃, and when the corresponding higher-order generalized singular values are equal: σ_{1,k}=σ_{2,k}=σ_{3,k}. Like the GSVD for two organisms, the HO GSVD provides a sequence-independent comparative mathematical framework for datasets from more than two organisms, where the mathematical variables and operations represent biological reality: genelets of common significance in the multiple datasets, and the corresponding arraylets, represent cell-cycle checkpoints or transitions from one phase to the next, common to S. pombe, S. cerevisiae and human. Simultaneous reconstruction and classification of the three datasets in the common subspace that these patterns span outlines the biological similarity in the regulation of their cell-cycle programs. Notably, genes of significantly different cell-cycle peak times but highly conserved sequences are correctly classified.

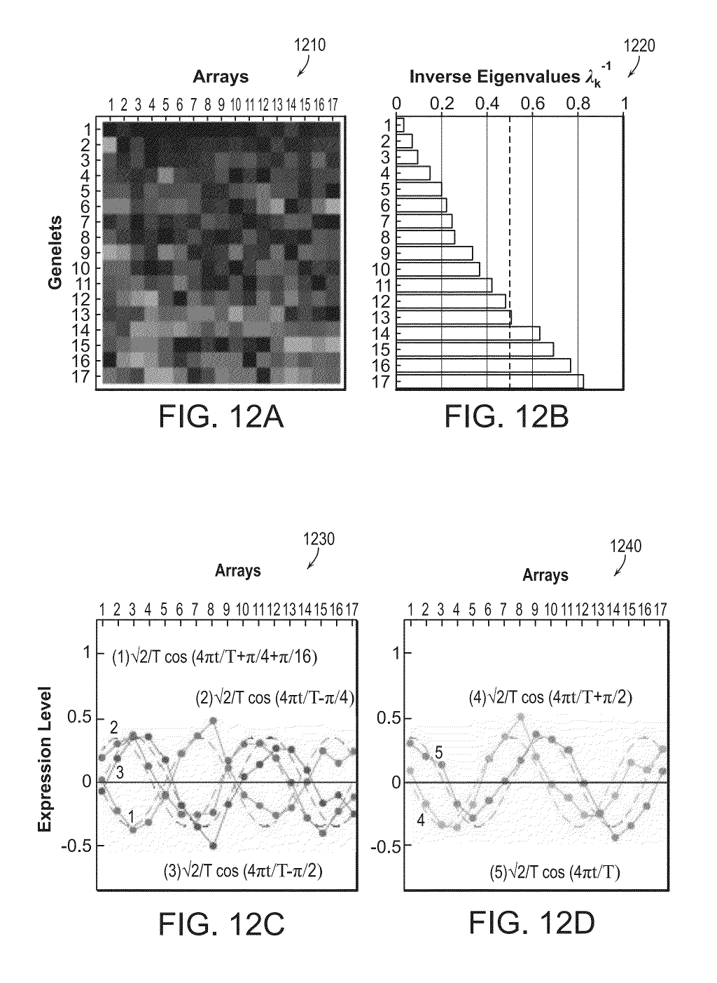

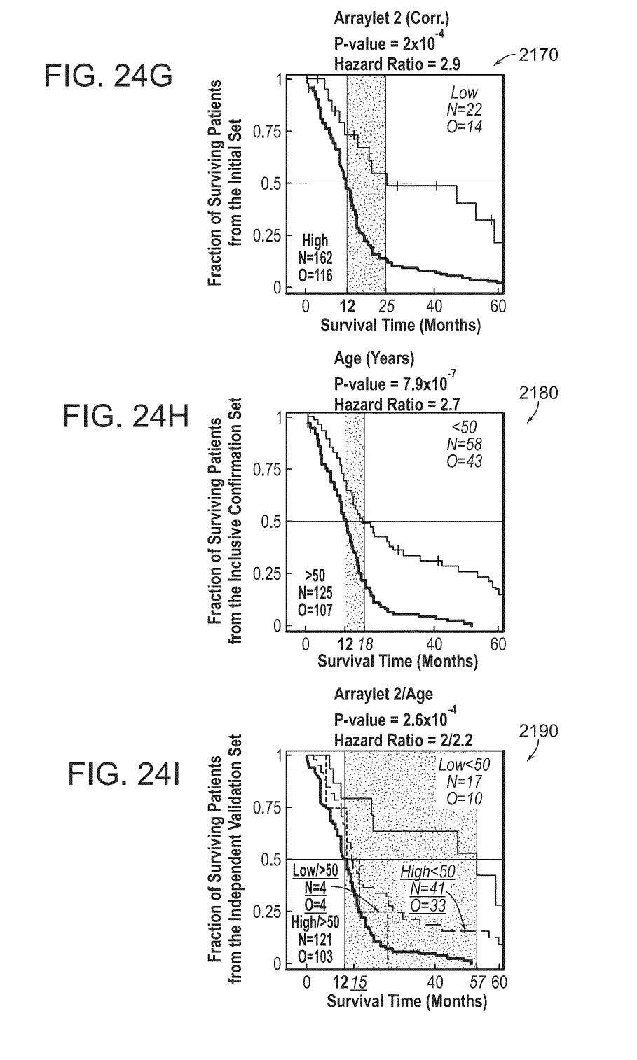

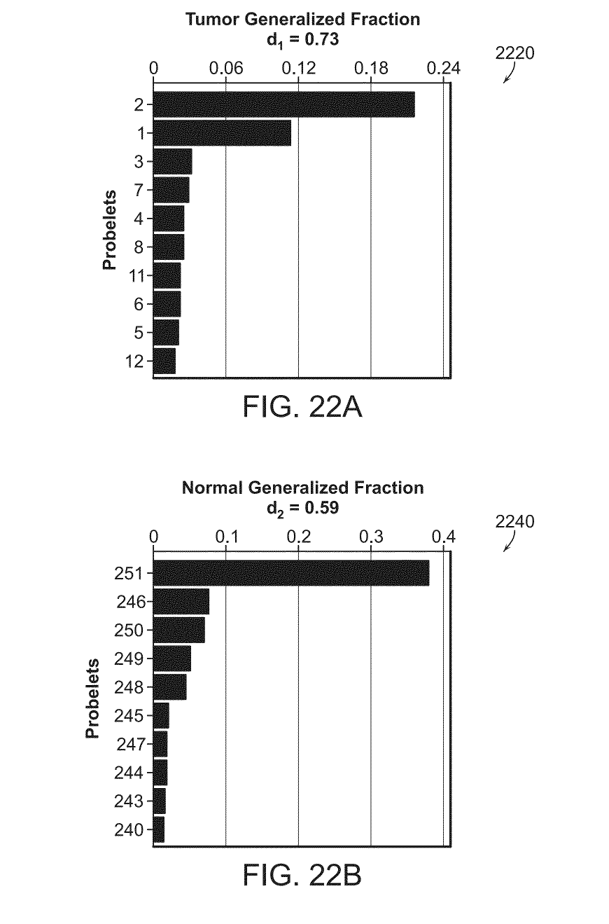

FIG. 12 is a diagram illustrating a right basis array 1210 and patterns of expression variation across time, according to some embodiments. The right basis array 1210 and bar chart 1220 and graphs 1230 and 1240 relate to application of HO GSVD algorithm for decomposition of global mRNA expression for multiple organisms. (a) Right basis array 1210 displays the expression of 17 genelets across 17 time points, with overexpression, no change in expression, and underexpression around the array-invariant, i.e., time-invariant expression. (b) The bar chart 1220 depicts the corresponding inverse eigenvalues λₖ⁻¹ showing that the 13th through the 17th genelets may be approximately equally significant in the three data sets with λₖ having a value approximately between 1 and 2, where the five corresponding arraylets in each data set are ε=0.33-orthonormal to all other arraylets (see FIG. 22). (c) The line joined graph 1230 of the 13th (1), 14th (3) and 15th (2) genelets in the two-dimensional subspace that approximates the five-dimensional HO GSVD subspace, normalized to zero average and unit variance. (d) The line-joined graphs 1240 show the projected 16th (4) and 17th (5) genelets in the two-dimensional subspace. The five genelets describe expression oscillations of two periods in the three time courses.

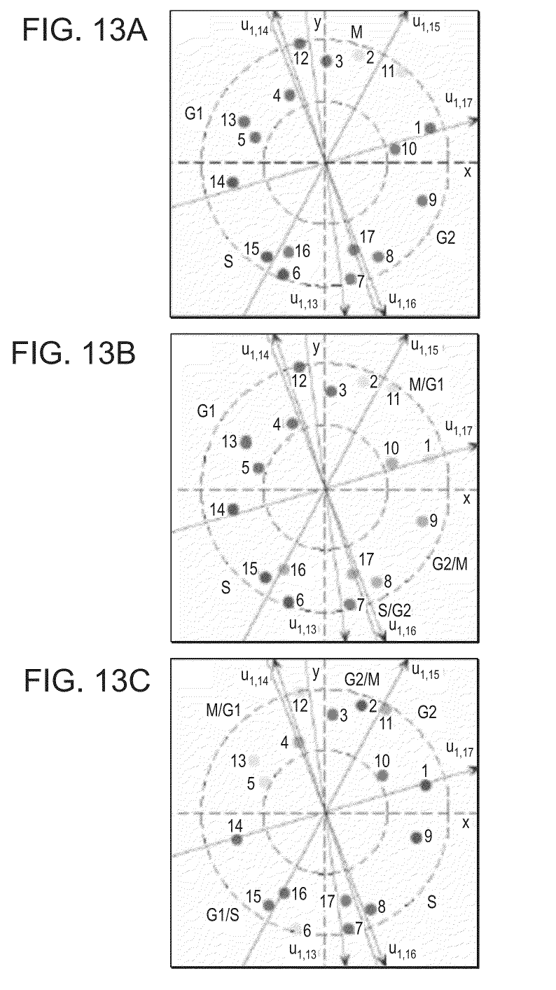

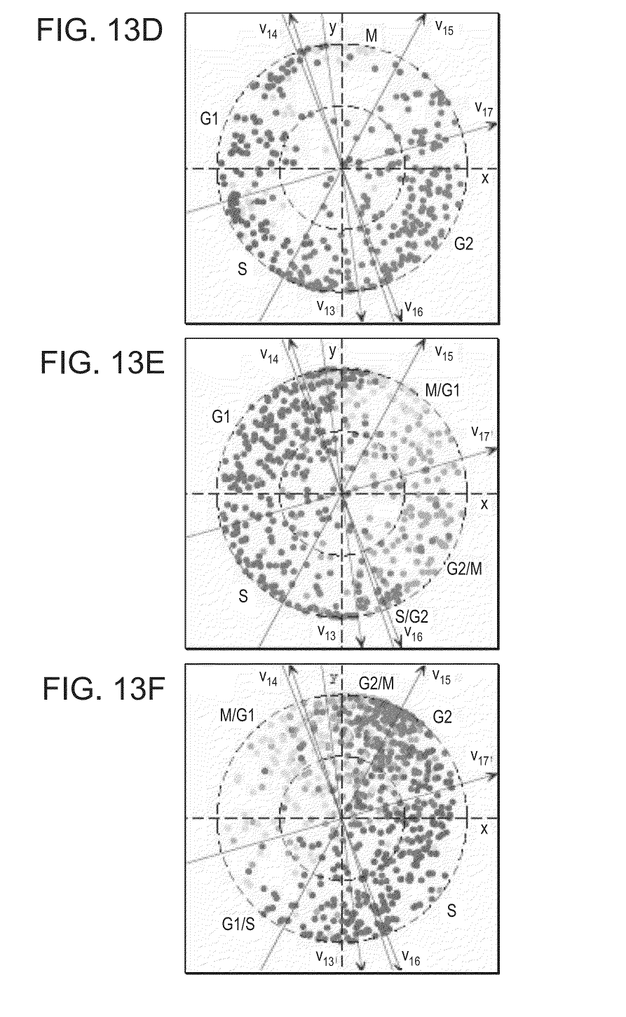

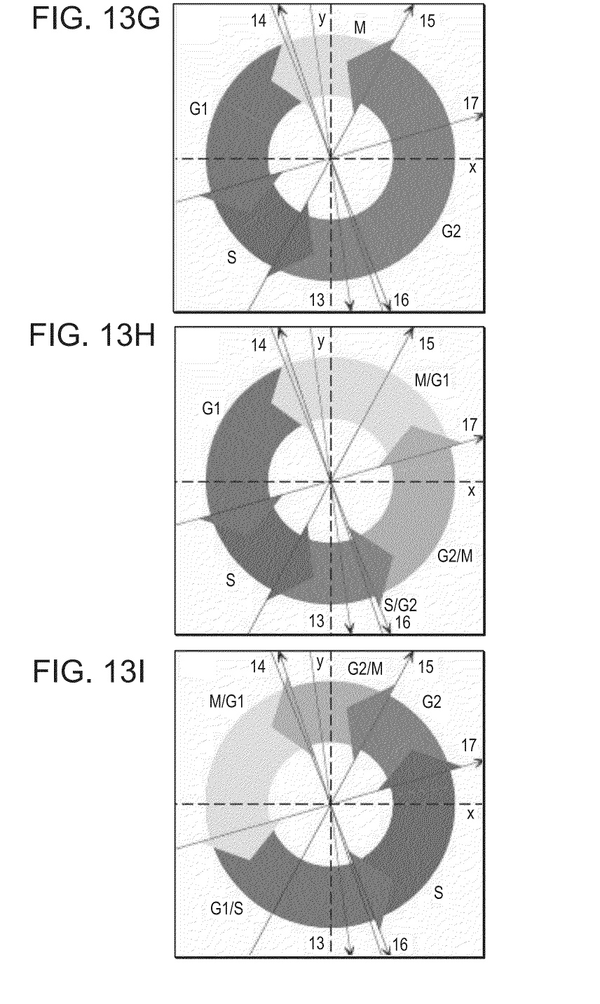

FIG. 13 is a diagram illustrating an HO GSVD reconstruction and classification of a number of mRNA expressions, according to some embodiments. Specifically, charts (a) to (i) shown in FIG. 13, relate to the simultaneous HO GSVD reconstruction and classification of S. pombe, S. cerevisiae and human global mRNA expression in the approximately common HO GSVD subspace. In charts (a-c) S. pombe, S. cerevisiae and human array expression are projected from the five-dimensional common HO GSVD subspace onto the two-dimensional subspace that approximates the common subspace. The arrays are color-coded according to their previous cell-cycle classification. The arrows describe the projections of the k=13, . . . , 17 arraylets of each data set. The dashed unit and half-unit circles outline 100% and 50% of added-up (rather than canceled-out) contributions of these five arraylets to the overall projected expression. In charts (d-f) Expression of 380, 641 and 787 cell cycle-regulated genes of S. pombe, S. cerevisiae and human, respectively, are color-coded according to previous classifications. Charts (g-i) show the HO GSVD pictures of the S. pombe, S. cerevisiae and human cell-cycle programs. The arrows describe the projections of the k=13, . . . , 17 shared genelets and organism-specific arraylets that span the common HO GSVD subspace and represent cell-cycle checkpoints or transitions from one phase to the next.

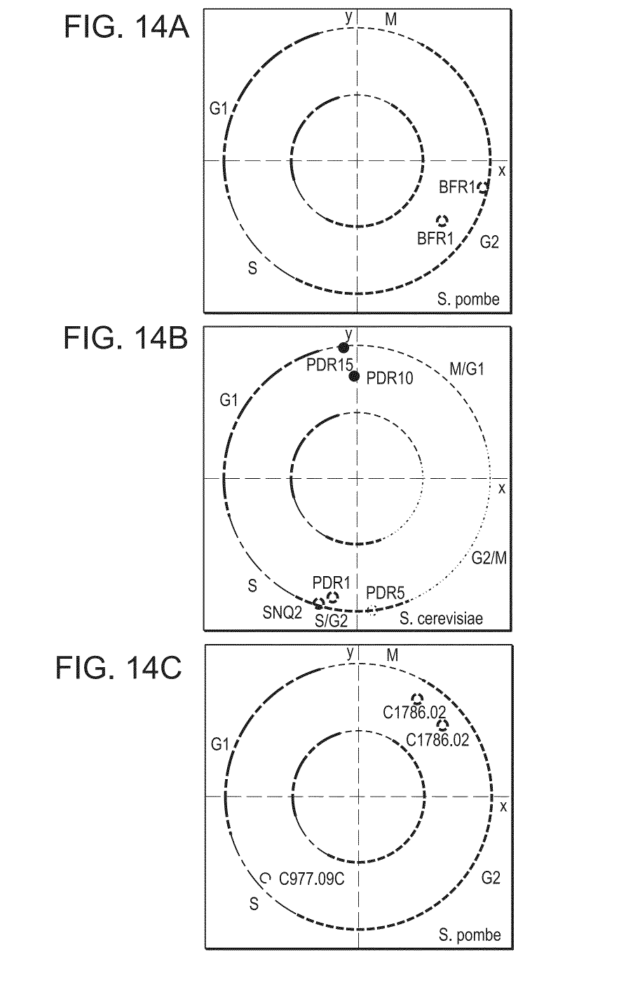

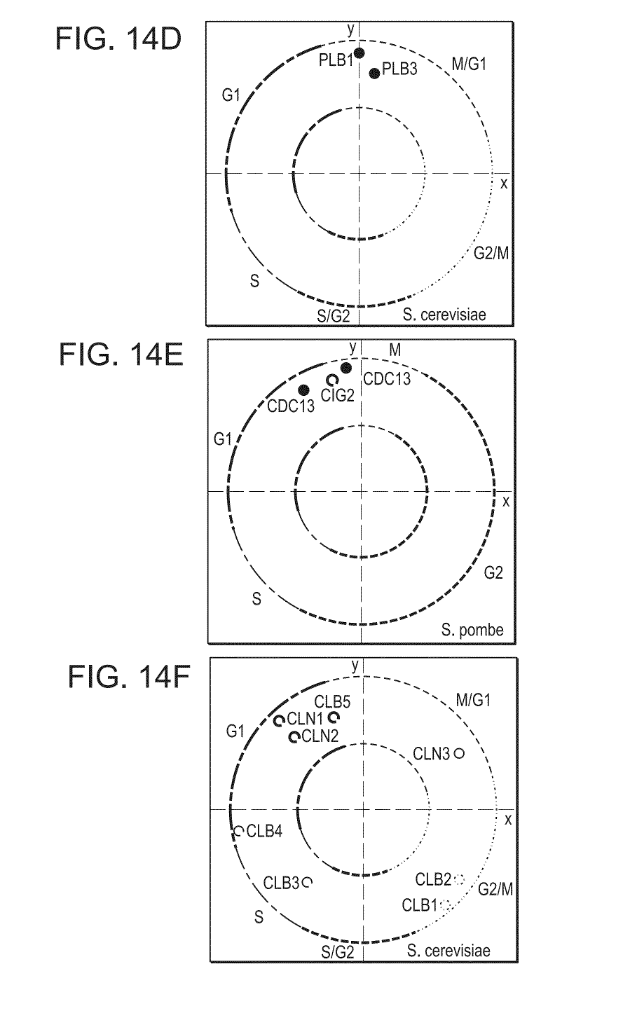

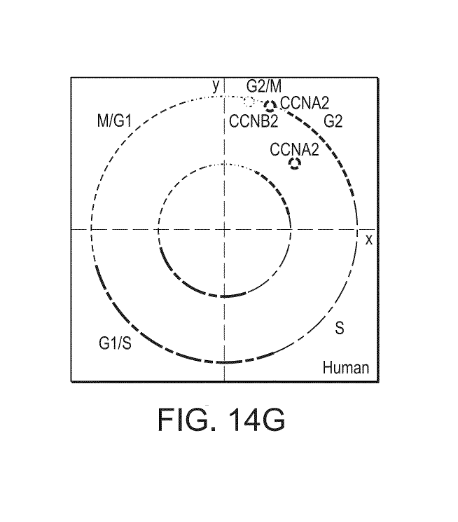

FIG. 14 is a diagram illustrating simultaneous HO GSVD sequence-independent classification of a number of genes, according to some embodiments. The genes under consideration in FIG. 14 are genes of significantly different cell-cycle peak times but highly conserved sequences. Chart (a) shows the S. pombe gene BFR1 and chart (b) shows its closest S. cerevisiae homologs. In Chart (c), the S. pombe and in chart (d), S. cerevisiae closest homologs of the S. cerevisiae gene PLB1 are shown. Chart (e) shows the S. pombe cyclin-encoding gene CIG2 and its closest S. pombe. Shown in chart (f) and (g) are the S. cerevisiae and human homologs, respectively.

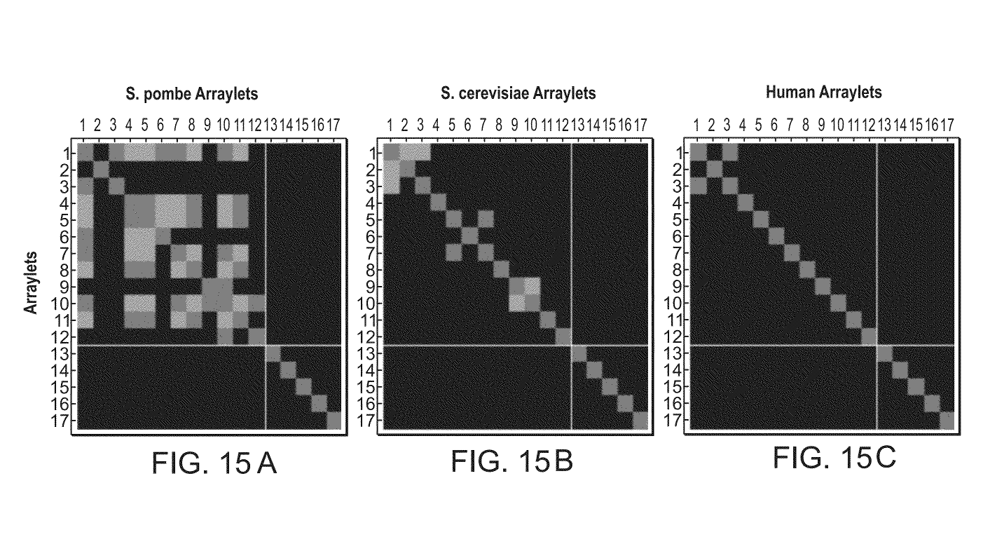

FIG. 15 is a diagram illustrating simultaneous correlations among n=17 arraylets in one organism, according to some embodiments. Raster displays of Uᵢ^{T}Ui, with correlations ≧ε=0.33, ≦−ε, and ∈(−ε, ε), show that for k=13, . . . , 17 the arraylets u_{i,k} with k 13, . . . , 17, that correspond to 1≦λₖ≦2, are ∈=0.33-orthonormal to all other arraylets in each data set. The corresponding five genelets, vₖ are approximately equally significant in the three data sets with σ_{1,k}:σ_{2,k}:σ_{3,k}˜1:1:1 in the S. pombe, S. cerevisiae and human datasets, respectively (FIG. 12). Following Theorem 3, therefore, these genelets span the, these arraylets and genelets may span the approximately “common HO GSVD subspace” for the three data sets.

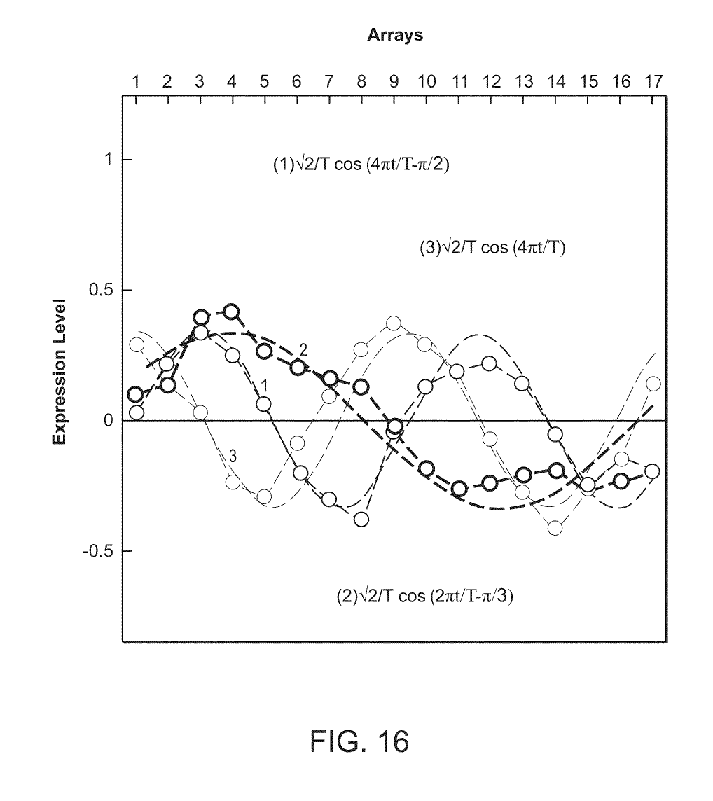

FIG. 16 is a diagram illustrating three dimensional least squares approximation of the five-dimensional approximately common HO GSVD subspace, according to some embodiments. Line joined graphs of the first (1), second (2) and third (3) most significant orthonormal vectors in the least squares approximation of the genelets vₖ with k=13, . . . , 17 are shown. These orthonormal vectors span the common HO GSVD subspace. This five-dimensional subspace may be approximated with the two orthonormal vectors x and y, which fit normalized cosine functions of two periods, and 0- and −π/2-initial phases, i.e., normalized zero-phase cosine and sine functions of two periods, respectively.

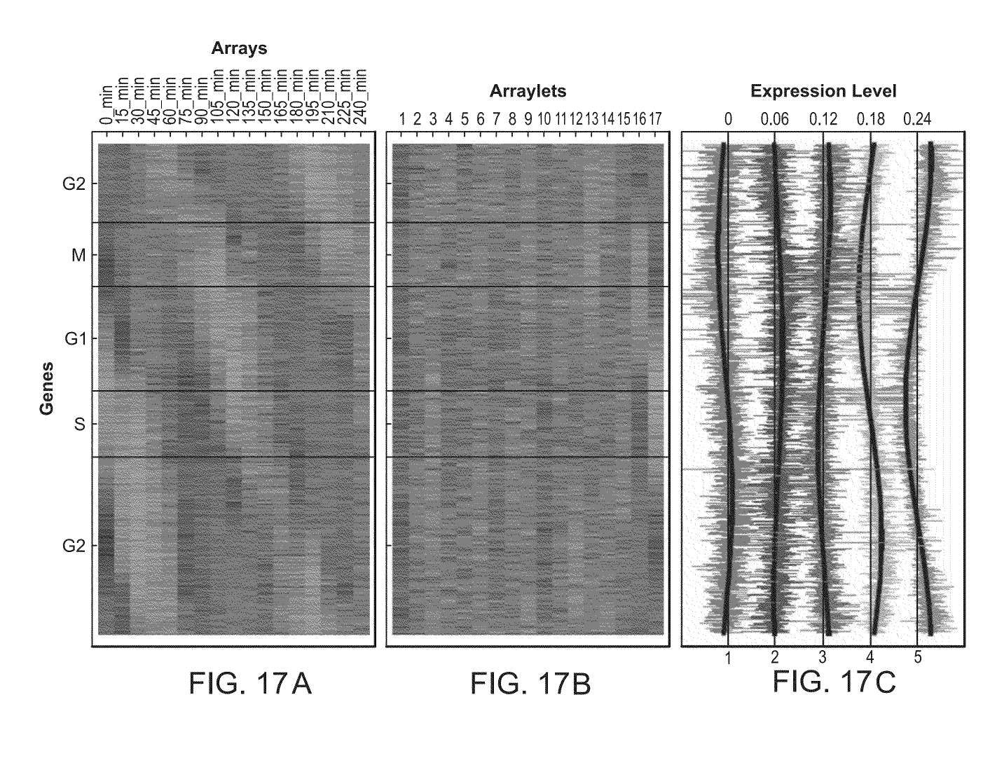

FIG. 17 is a diagram illustrating an example of an mRNA expression (S. pombe global mRNA expression) reconstructed in the five-dimensional approximately common HO GSVD subspace, according to some embodiments. The example mRNA expression may include S. pombe global mRNA expression reconstructed in the five-dimensional common HO GSVD subspace with genes sorted according to their phases in the two-dimensional subspace that approximates it. Chart (a) is an expression of the sorted 3167 genes in the 17 arrays, centered at their gene- and array-invariant levels, showing a traveling wave of expression. Chart (b) shows an expression of the sorted genes in the 17 arraylets, centered at their arraylet-invariant levels. Arraylets k=13, . . . , 17 display the sorting. Chart (c) depicts line-joined graphs of the 13th (1), 14th (2), 15th (3), 16th (4) and 17th (5) arraylets t one-period cosines with initial phases similar to those of the corresponding genelets (similar to probelets in FIG. 11).

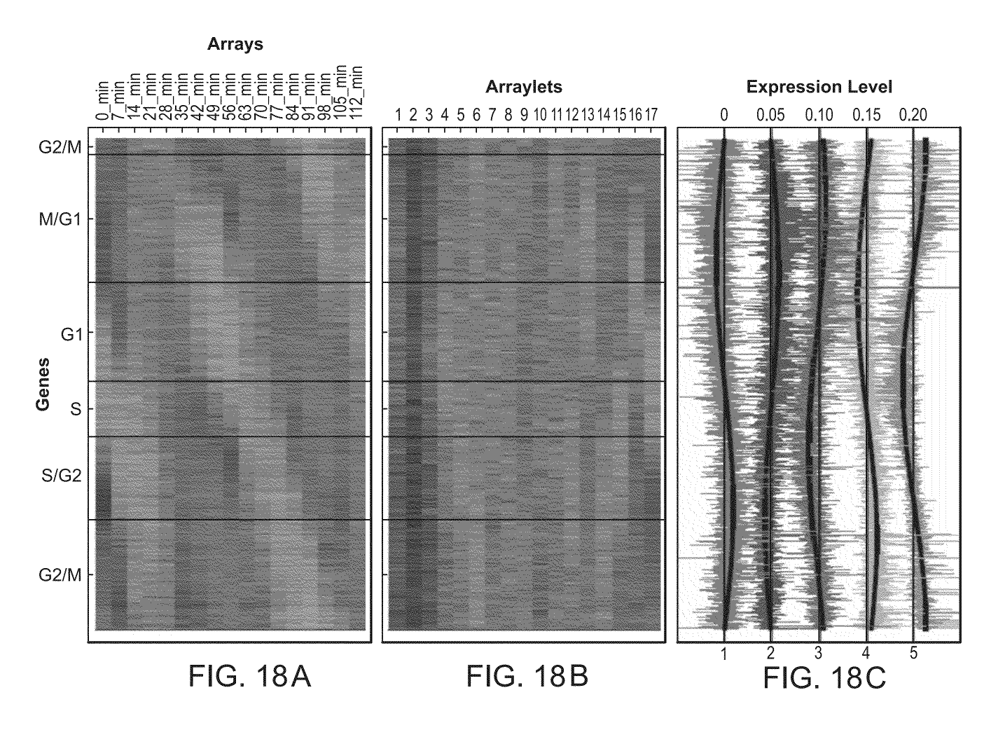

FIG. 18 is a diagram illustrating another example of an mRNA expression (S. cerevisiae global mRNA expression) reconstructed in the five-dimensional approximately common HO GSVD subspace, according to some embodiments. The example mRNA expression includes S. cerevisiae global mRNA expression reconstructed in the five-dimensional common HO GSVD subspace with genes sorted according to their phases in the two-dimensional subspace that approximates it. Chart (a) is an expression of the sorted 4772 genes in the 17 arrays, centered at their gene- and array-invariant levels, showing a traveling wave of expression. Chart (b) shows an expression of the sorted genes in the 17 arraylets, centered at their arraylet-invariant levels, where arraylets k=13, . . . , 17 display the sorting. Chart (c) depicts line-joined graphs of the 13th (1), 14th (2), 15th (3), 16th (4) and 17th (5) arraylets fit one-period cosines with initial phases similar to those of the corresponding genelets.

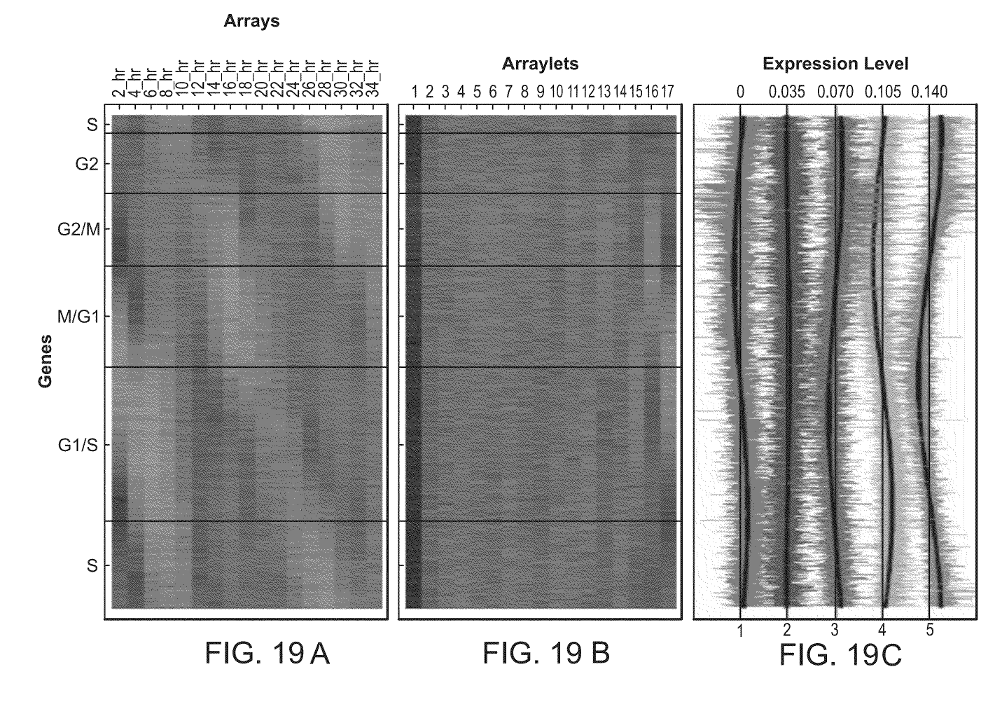

FIG. 19 is a diagram illustrating a human global mRNA expression reconstructed in the five-dimensional approximately common HO GSVD subspace, according to some embodiments. The genes are sorted according to their phases in the two-dimensional subspace that approximates them. Chart (a) is an expression of the sorted 13,068 genes in the 17 arrays, centered at their gene- and array-invariant levels, showing a traveling wave of expression. Chart (b) shows an expression of the sorted genes in the 17 arraylets, centered at their arraylet-invariant levels, where arraylets k=13, . . . , 17 display the sorting. Chart (c) shows line-joined graphs of the 13th (1), 14th (2), 15th (3), 16th (4) and 17th (5) arraylets fit one-period cosines with initial phases that may be similar to those of the corresponding genelets.

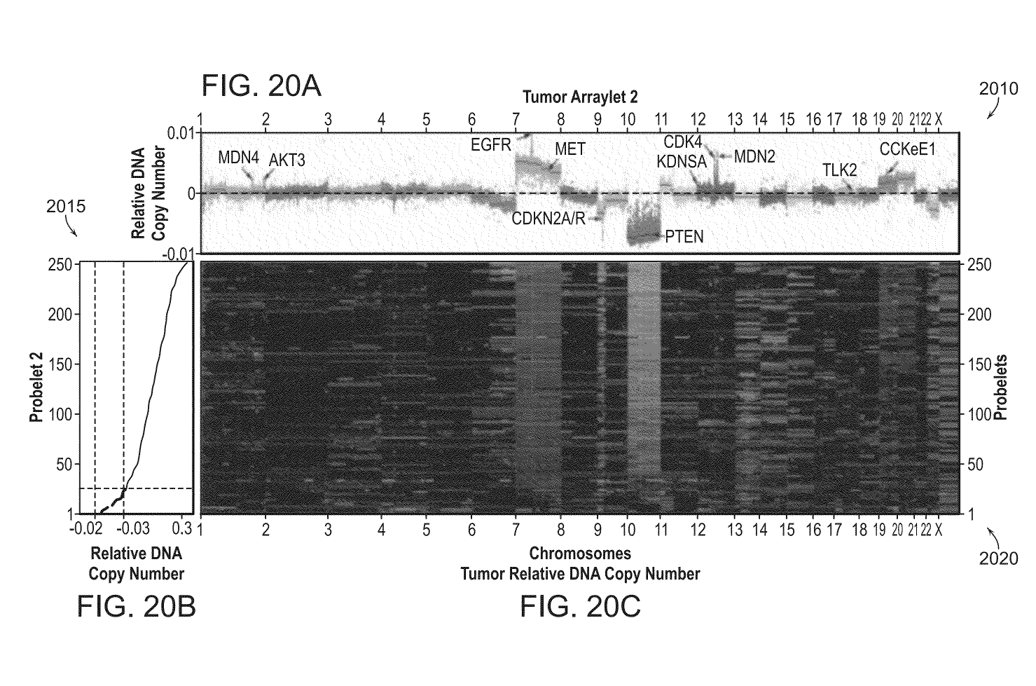

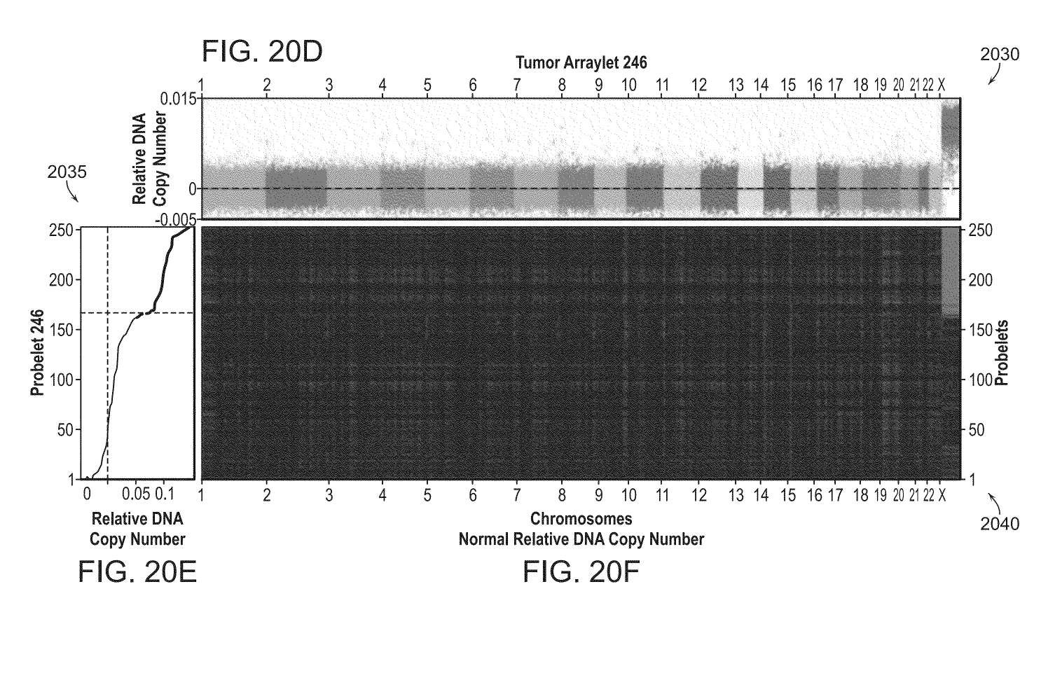

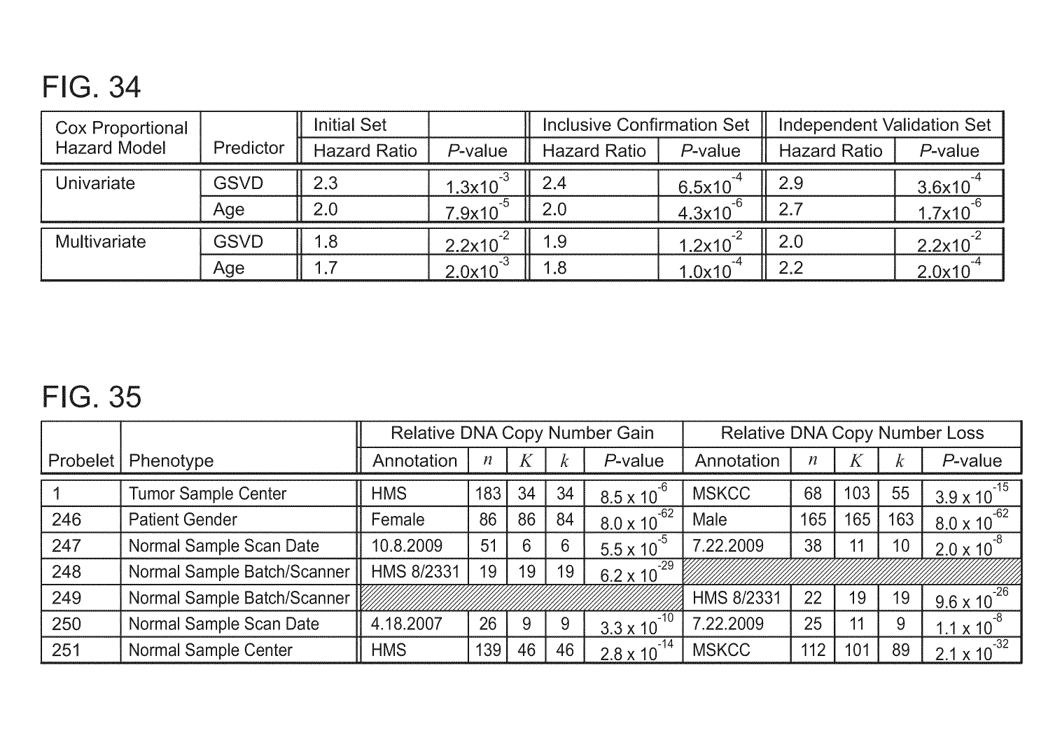

FIG. 20 is a diagram illustrating significant probelets and corresponding tumor and normal arraylets uncovered by GSVD of the patient-matched GBM and normal blood aCGH profiles, according to some embodiments. (a) A chart 2010 is a plot of the second tumor arraylet and describes a global pattern of tumor-exclusive co-occurring CNAs across the tumor probes. The probes are ordered, and their copy numbers are colored, according to each probe's chromosomal location. Segments (black lines) identified by circular binary segmentation (CBS) include most known GBM-associated focal CNAs, e.g., Epidermal growth factor receptor (EGFR) amplification. CNAs previously unrecognized in GBM may include an amplification of a segment containing the biochemically putative drug target-encoding. (b) A chart 2015 shows a plot of a probelet that may be identified as the second most tumor-exclusive probelet, which may also be identified as the most significant probelet in the tumor data set, describes the corresponding variation across the patients. The patients are ordered and classified according to each patient's relative copy number in this probelet. There are 227 patients with high (>0.02) and 23 patients with low, approximately zero, numbers in the second probelet. One patient remains unclassified with a large negative (<−0.02) number. This classification may significantly correlate with GBM survival times. (c) A chart 2020 is a raster display of the tumor data set, with relative gain, no change, and loss of DNA copy numbers, which may show the correspondence between the GBM profiles and the second probelet and tumor arraylet. Chromosome 7 gain and losses of chromosomes 9p and 10, which may be dominant in the second tumor arraylet (see 2220 in FIG. 22), may be negligible in the patients with low copy numbers in the second probelet, but may be distinct in the remaining patients (see 2240 in FIG. 22). This may illustrate that the copy numbers listed in the second probelet correspond to the weights of the second tumor arraylet in the GBM profiles of the patients. (d) A chart 2030 is a plot of the 246th normal arraylet, which describes an X chromosome-exclusive amplification across the normal probes. (e) A chart 2035 shows a plot of the 246th probelet, which may be approximately common to both the normal and tumor data sets, and second most significant in the normal data set (see 2240 in FIG. 22), may describe the corresponding copy-number amplification in the female relative to the male patients. Classification of the patients by the 246th probelet may agree with the copy-number gender assignments (see table in FIG. 34), also for three patients with missing TCGA gender annotations and three additional patients with conflicting TCGA annotations and copy-number gender assignments. (f) Chart 2040 is a raster display of the normal data set, which may show the correspondence between the normal blood profiles and the 246th probelet and normal arraylet. X chromosome amplification, which may be dominant in the 246th normal arraylet (Chart 2040), may be distinct in the female but nonexisting in the male patients (Figure Chart 2035). Note also that although the tumor samples exhibit female-specific X chromosome amplification (Chart 2020), the second tumor arraylet (Chart 2010) exhibits an unsegmented X chromosome copy-number distribution, that is approximately centered at zero with a relatively small width.

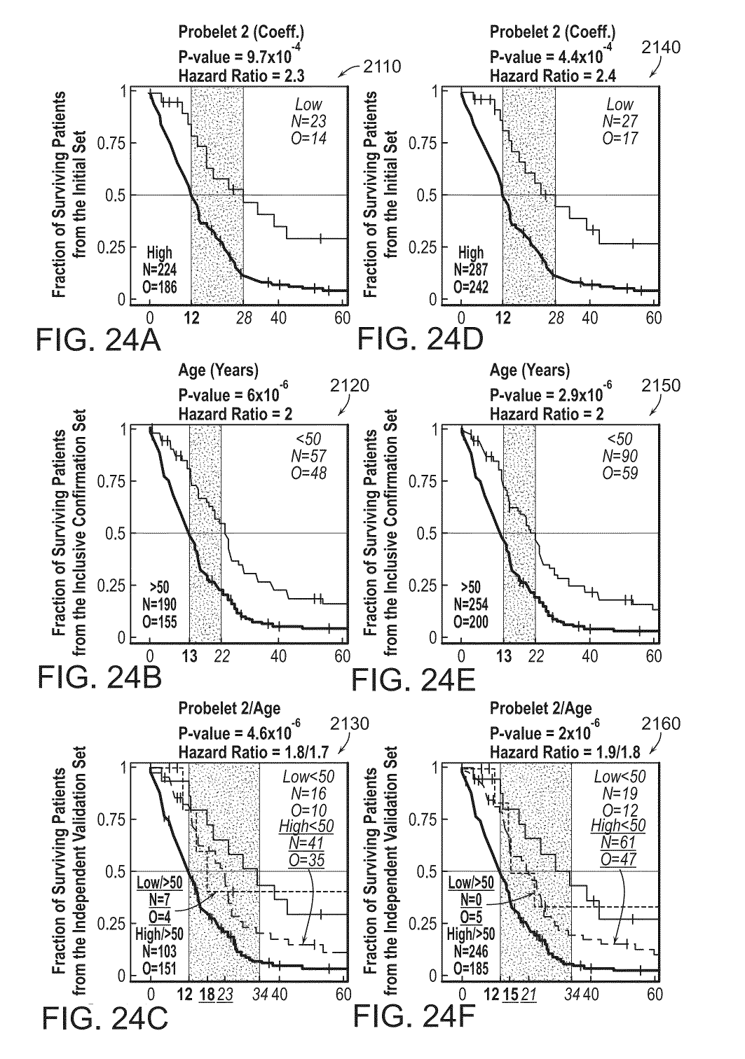

FIG. 21 is a diagram illustrating survival analyses of three sets of patients classified by GSVD, age at diagnosis or both, according to some embodiments. (a) A graph 2110 shows Kaplan-Meier curves for the 247 patients with TCGA annotations in the initial set of 251 patients, classified by copy numbers in the second probelet, which is computed by GSVD for 251 patients, which may indicate a KM median survival time difference of nearly 16 months, with the corresponding log-rank test P-value <10³. The univariate Cox proportional hazard ratio is 2.3, with a P-value <10⁻² (see table in FIG. 34), which may suggest that high relative copy numbers in the second probelet confer more than twice the hazard of low numbers. (b) A graph 2120 shows KM and Cox survival analyses for the 247 patients classified by age, i.e., >50 or <50 years old at diagnosis, which may indicate that the prognostic contribution of age, with a KM median survival time difference of nearly 11 months and a univariate hazard ratio of 2, is comparable to that of GSVD. (c) A graph 2130 shows Survival analyses for the 247 patients classified by both GSVD and age, which may indicate similar multivariate Cox hazard ratios, of 1.8 and 1.7, that do not differ significantly from the corresponding univariate hazard ratios, of 2.3 and 2, respectively. This may signify that GSVD and age may be independent prognostic predictors. With a KM median survival time difference of approximately 22 months, GSVD and age combined make a better predictor than age alone. (d) A graph 2140 shows Survival analyses for the 334 patients with TCGA annotations and a GSVD classification in the inclusive confirmation set of 344 patients, classified by copy numbers in the second probelet, which is computed by GSVD for the 344 patients, which may indicate a KM median survival time difference of nearly 16 months and a univariate hazard ratio of 2.4, and confirm the survival analyses of the initial set of 251 patients. (e) A graph 2150 shows Survival analyses for the 334 patients classified by age confirm that the prognostic contribution of age, with a KM median survival time difference of approximately 10 months and a univariate hazard ratio of 2, is comparable to that of GSVD. (f) A graph 2160 shows Survival analyses for the 334 patients classified by both GSVD and age, which may indicate similar multivariate Cox hazard ratios, of 1.9 and 1.8, that may not differ significantly from the corresponding univariate hazard ratios, and a KM median survival time difference of nearly 22 months, with the corresponding log-rank test P-value <10⁵. This result may confirm that the prognostic contribution of GSVD is independent of age, and that combined with age, GSVD makes a better predictor than age alone. (g) A graph 2170 shows survival analyses for the 183 patients with a GSVD classification in the independent validation set of 184 patients, classified by correlations of each patient's GBM profile with the second tumor arraylet, which can be computed by GSVD for the 251 patients, which may indicate a KM median survival time difference of nearly 12 months and a univariate hazard ratio of 2.9, and may validate the survival analyses of the initial set of 251 patients. (h) A graph 2180 shows survival analyses for the 183 patients classified by age, which may validate that the prognostic contribution of age is comparable to that of GSVD. (i) A graph 2190 shows survival analyses for the 183 patients classified by both GSVD and age, which may indicate similar multivariate Cox hazard ratios, of 2 and 2.2, and a KM median survival time difference of nearly 41 months, with the corresponding log-rank test P-value <10⁵. This result may validate that the prognostic contribution of GSVD is independent of age, and that combined with age, GSVD may make a better predictor than age alone, also for patients with measured GBM aCGH profiles in the absence of matched normal blood profiles.

FIG. 22 is a diagram illustrating most significant probelets in tumor and normal data sets, age at diagnosis or both, according to some embodiments. (a) Bar charts 2220 and 2240 show the ten significant probelets in the tumor data set and the generalized fraction that each probelet captures in this data set. The generalized fraction are given as P_{1,n} and P_{2,n} below in terms of the normalized values for σ²_{1,n} and σ²_{2,n}:

$${P}_{1 , n} = {σ}_{1 , n}^{2} / {\sum }_{n = 1}^{N} {σ}_{1 , n}^{2} , \\ {P}_{2 , n} = {σ}_{2 , n}^{2} / {\sum }_{n = 1}^{N} {σ}_{2 , n}^{2} .$$

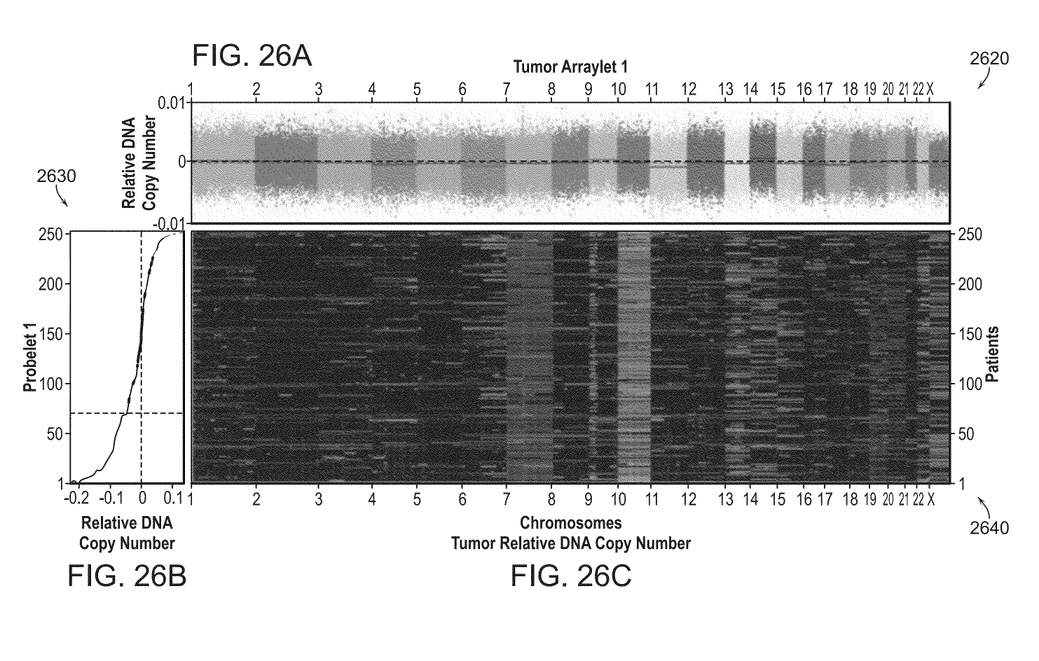

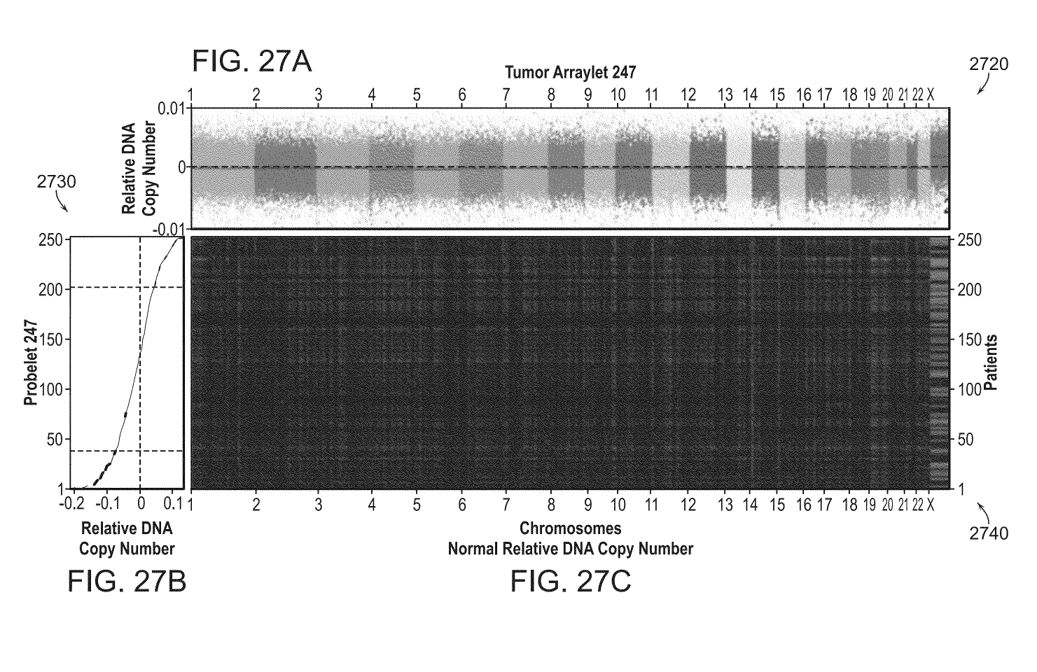

The results shown in bar charts 2220 and 2240 may indicate that the two most tumor-exclusive probelets, i.e., the first probelet (see FIG. 26) and the second probelet (see FIG. 20, 2010-2020), with angular distances >2π/9, may also be the two most significant probelets in the tumor data set, with ˜11% and 22% of the information in this data set, respectively. The “generalized normalized Shannon entropy” (Equation 3 in Appendix A) of the tumor dataset is d₁=0.73. (b) Bar chart 2240 shows ten significant probelets in the normal data set and the generalized fraction that each probelet captures in this data set, which may indicate that the five most normal-exclusive probelets, the 247th to 251st probelets (see FIGS. 27-31), with angular distances approximately <≈−π/6, may be among the seven most significant probelets in the normal data set, capturing together ˜56% of the information in this data set. The 246th probelet (see FIG. 20, 2030-2040), which is relatively common to the normal and tumor data sets with an angular distance >−π/6, may be the second most significant probelet in the normal data set with ˜8% of the information. The generalized entropy of the normal dataset, d₂=0.59, is smaller than that of the tumor dataset. This means that the normal dataset is more redundant and less complex than the tumor dataset.

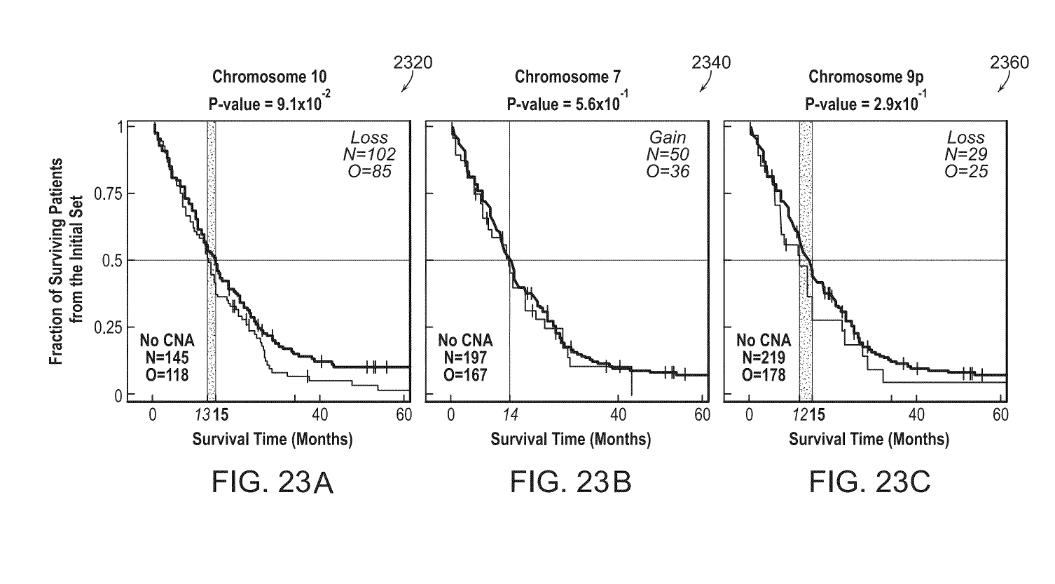

FIG. 23 is a diagram illustrating a survival analysis of an initial set of a number of patients classified by GBM-associated chromosome number changes, according to some embodiments. Graphs 2320-2360 shown in FIG. 23 are Kaplan-Meier survival analyses of the initial set of 251 patients classified by GBM-associated chromosome number changes. (a) The graph 2320 shows a Kaplan-Meier survival analysis for the 247 patients with TCGA annotations in the initial set of 251 patients, classified by number changes in chromosome 10, which may indicate almost overlapping KM curves with a KM median survival time difference of ˜2 months, and a corresponding log-rank test P-value ˜10⁻¹. This result may mean that chromosome 10 loss, frequently observed in GBM, is a poor predictor of GBM survival. (b) The graph 2340 depicts a KM survival analysis for the 247 patients classified by number changes in chromosome 7, which may indicate almost overlapping KM curves with a KM median survival time difference of <one month, and a corresponding log-rank test P-value >5×10⁻¹. This result may suggest that chromosome 7 gain is a poor predictor of GBM survival. (c) The graph 2360 shows a KM survival analysis for the 247 patients classified by number changes in chromosome 9p, which may indicate a KM median survival time difference of ˜3 months, and a log-rank test P-value >10⁻¹. This result may signify that chromosome 9p loss is a poor predictor of GBM survival.

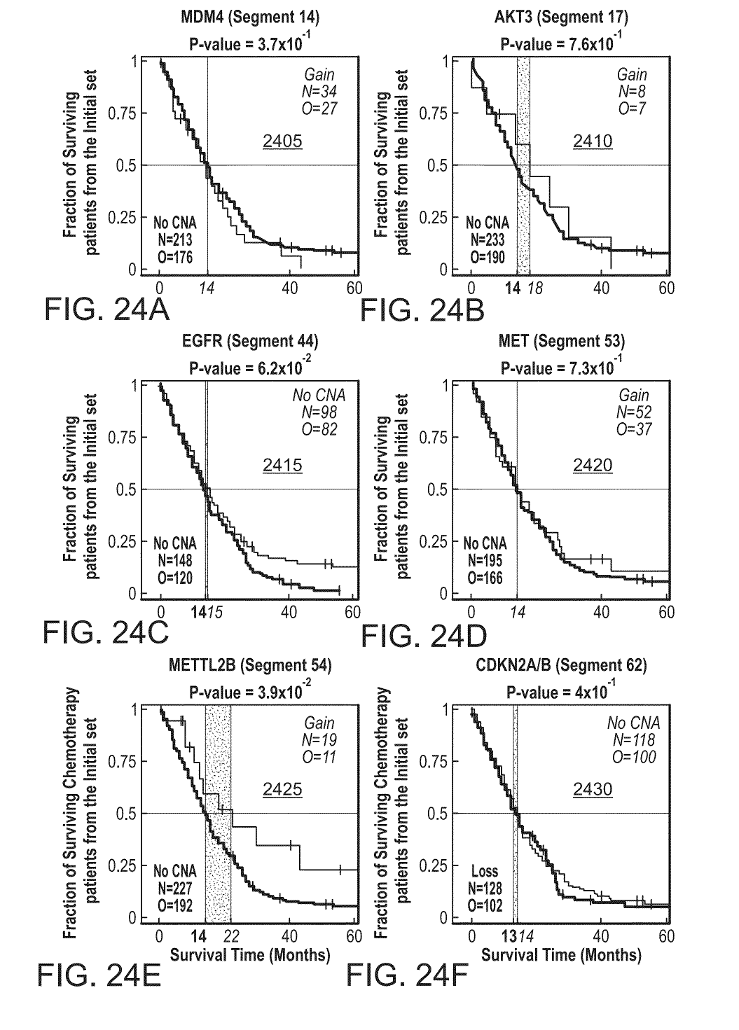

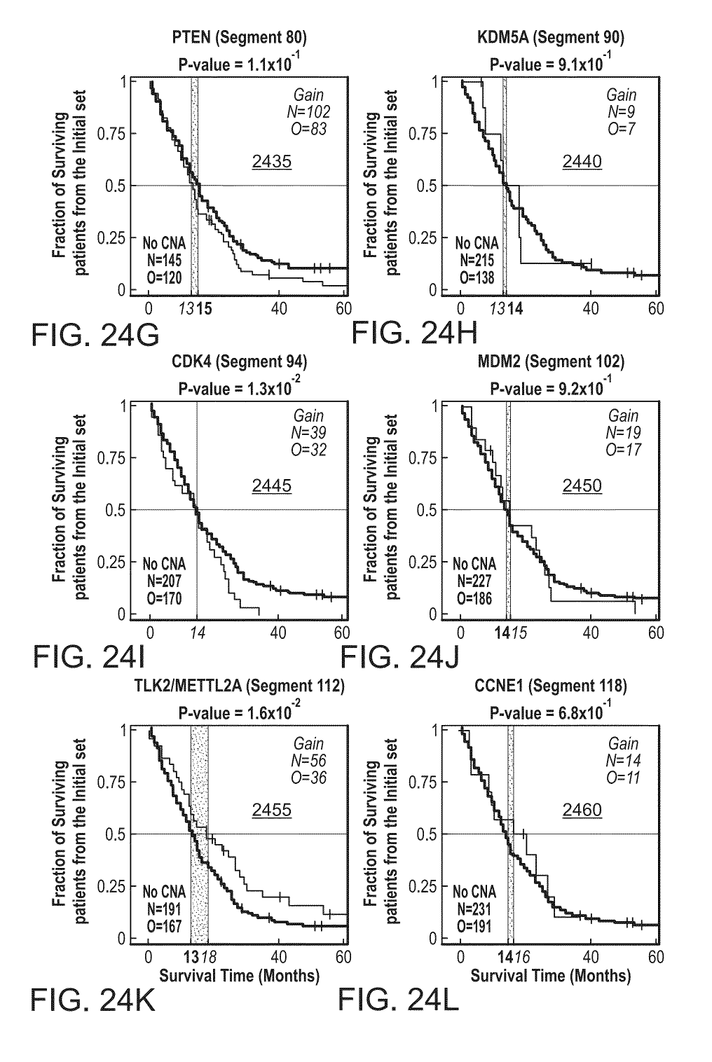

FIG. 24 is a diagram illustrating a survival analysis of an initial set of a number of patients classified by copy number changes in selected segments, according to some embodiments. Graphs 2405-2460 show KM survival analyses of the initial set of 251 patients classified by copy number changes in selected segments containing GBM-associated genes or genes previously unrecognized in GBM. In the KM survival analyses for the groups of patients with either a CNA or no CNA in either one of the 130 segments identified by the global pattern, i.e., the second tumor-exclusive arraylet (Dataset S3), log-rank test P-values <5×10⁻² are calculated for only 12 of the classifications. Of these, only six may correspond to a KM median survival time difference that is≈>5 months, approximately a third of the ˜16 months difference observed for the GSVD classification. One of these segments may contain the genes TLK2 and METTL2A, previously unrecognized in GBM. The KM median survival time can be calculated for the 56 patients with TLK2 amplification, which is ˜5 months longer than that for the remaining patients. This may suggest that drug-targeting the kinase and/or the methyltransferase-like protein that TLK2 and METTL2A encode, respectively, may affect not only the pathogenesis but also the prognosis of GBM.

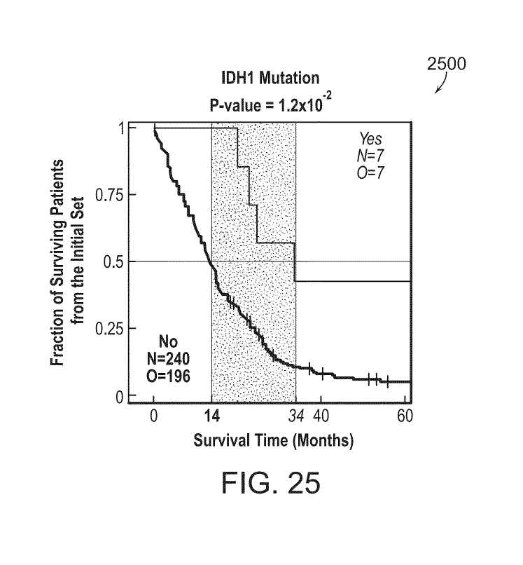

FIG. 25 is a diagram illustrating a survival analysis of an initial set of a number of patients, according to some embodiments. Graph 2500 shows a result of a KM survival analysis of an initial set of 251 patients classified by a mutation in the gene IDH1.

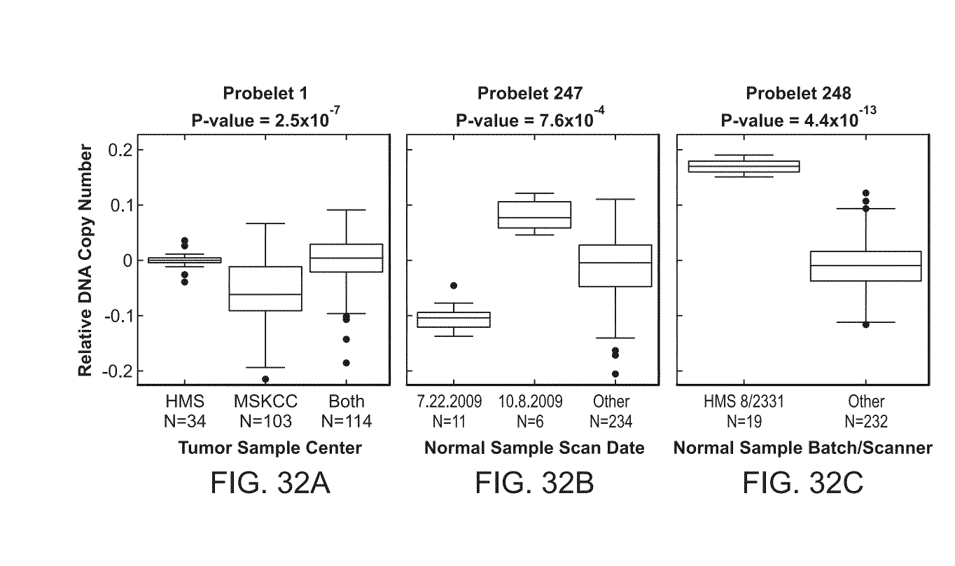

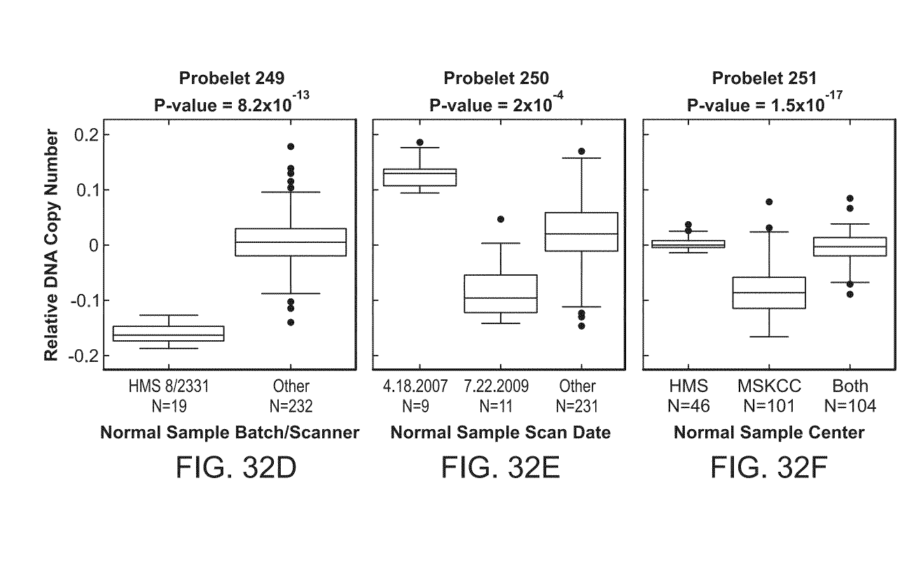

FIG. 26 is a diagram illustrating a significant probelet and corresponding tumor arraylet, according to some embodiments. This probelet may be the first most tumor-exclusive probelet, which is shown with corresponding tumor arraylet uncovered by GSVD of the patient-matched GBM and normal blood aCGH profiles. (a) A plot 2620 of the first tumor arraylet describes unsegmented chromosomes (black lines), each with copy-number distributions which are approximately centered at zero with relatively large, chromosome-invariant widths. The probes are ordered, and their copy numbers are colored, according to each probe's chromosomal location. (b) A graph 2630 of the first most tumor-exclusive probelet, which is also the second most significant probelet in the tumor data set (see 2220 in FIG. 22), describes the corresponding variation across the patients. The patients are ordered according to each patient's relative copy number in this probelet. These copy numbers may significantly correlate with the genomic center where the GBM samples were hybridized at, HMS, MSKCC, or multiple locations, with the P-values <10⁵ (see Table in FIG. 35 and FIG. 32). (c) A raster display 2640 of the tumor data set, with relative gain, no change, and loss of DNA copy numbers, may indicate the correspondence between the GBM profiles and the first probelet and tumor arraylet.

FIG. 27 is a diagram illustrating a normal-exclusive probelet and corresponding normal arraylet uncovered by GSVD, according to some embodiments. The normal-exclusive probelet is 247th, normal-exclusive probelet and corresponding normal arraylet is uncovered by GSVD. (a) A plot 2720 of the 247th normal arraylet describes copy-number distributions which are approximately centered at zero with relatively large, chromosome-invariant widths. The normal probes are ordered, and their copy numbers are colored, according to each probe's chromosomal location. (b) A plot 2730 of the 247th probelet may describe the corresponding variation across the patients. Copy numbers in this probelet may correlate with the date of hybridization of the normal blood samples, 7.22.2009, 10.8.2009, or other, with the P-values <10⁻³ (see the Table in FIG. 35 and FIG. 32). (c) A raster display 2740 of the normal data set shows the correspondence between the normal blood profiles and the 247th probelet and normal arraylet.

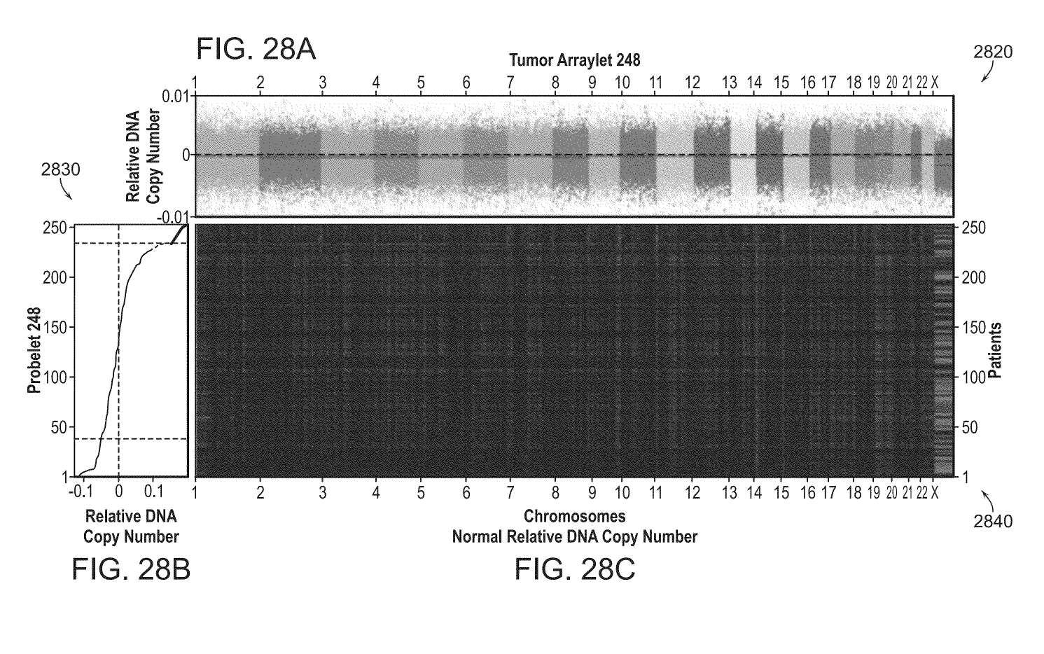

FIG. 28 is a diagram illustrating a normal-exclusive probelet and corresponding normal arraylet uncovered by GSVD, according to some embodiments. The normal-exclusive probelet is 248th, normal-exclusive probelet and the corresponding normal arraylet is uncovered by GSVD. (a) A Plot 2820 of the 248th normal arraylet describes copy-number distributions which are approximately centered at zero with relatively large, chromosome-invariant widths. (b) A Plot 2830 of the 248th probelet describes the corresponding variation across the patients. Copy numbers in this probelet may significantly correlate with the tissue batch/hybridization scanner of the normal blood samples, HMS 8/2331 and other, with the P-values <10⁻¹² (see the Table in FIG. 35 and FIG. 32). (c) A raster display 2840 of the normal data set may show the correspondence between the normal blood profiles and the 248th probelet and normal arraylet.

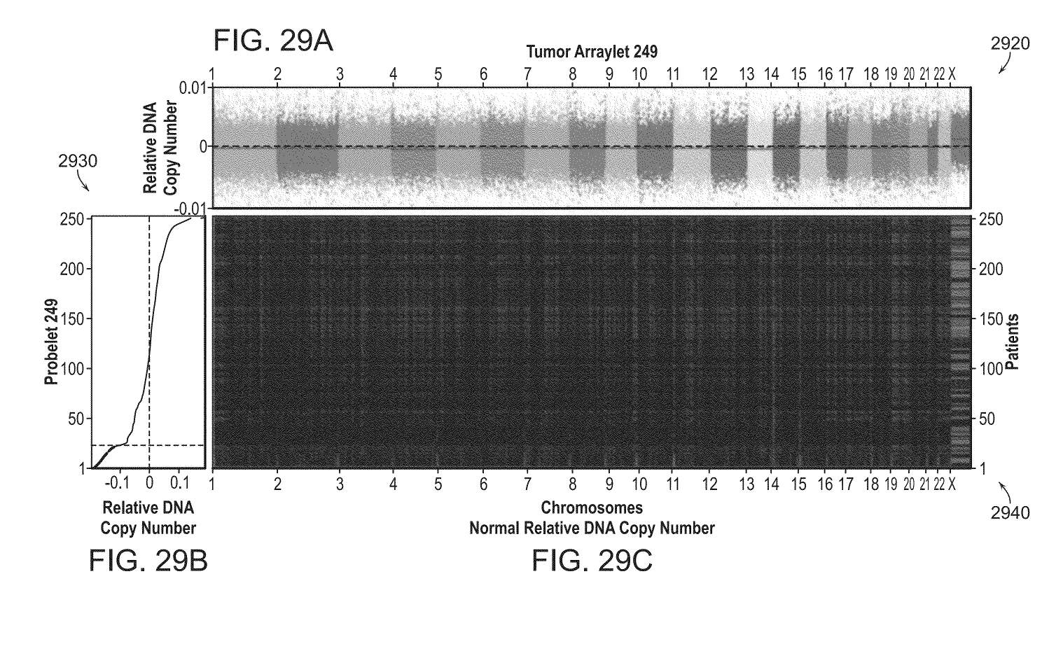

FIG. 29 is a diagram illustrating another normal-exclusive probelet and corresponding normal arraylet uncovered by GSVD, according to some embodiments. The normal-exclusive probelet is 249th, normal-exclusive probelet and the corresponding normal arraylet is uncovered by GSVD. (a) A Plot 2920 of the 249th normal arraylet describes copy-number distributions which are approximately centered at zero with relatively large, chromosome-invariant widths. (b) A Plot 2930 of the 249th probelet describes the corresponding variation across the patients. Copy numbers in this probelet may significantly correlate with the tissue batch/hybridization scanner of the normal blood samples, HMS 8/2331 and other, with the P-values <10⁻¹² (see the Table in FIG. 35 and FIG. 32). (c) A raster display 2940 of the normal data set may show the correspondence between the normal blood profiles and the 249th probelet and normal arraylet.

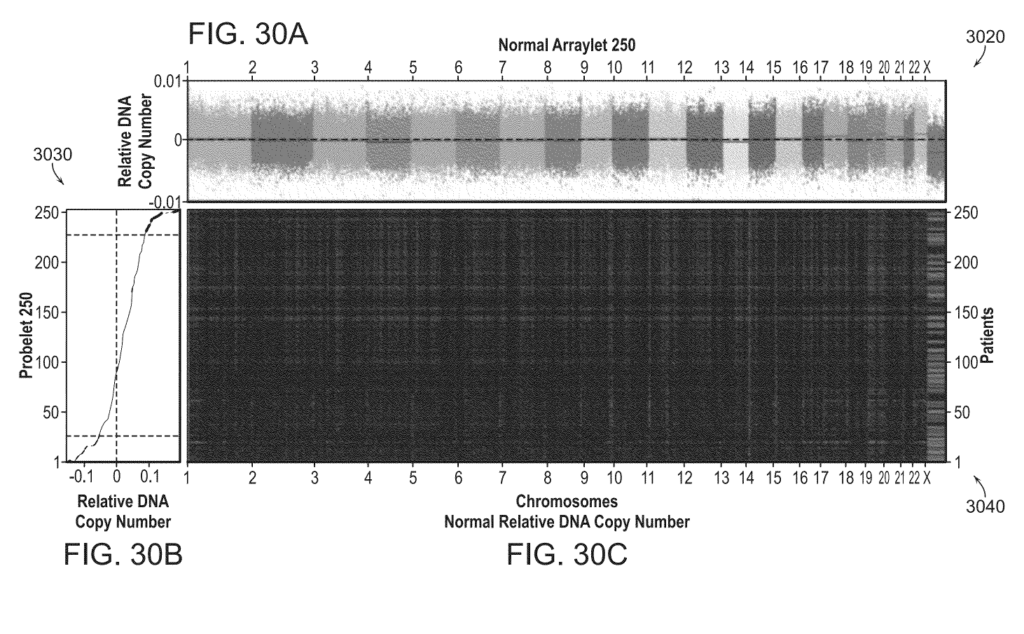

FIG. 30 is a diagram illustrating yet another normal-exclusive probelet and corresponding normal arraylet uncovered by GSVD, according to some embodiments. The normal-exclusive probelet is 250th, normal-exclusive probelet and the corresponding normal arraylet is uncovered by GSVD. (a) A Plot 3020 of the 250th normal arraylet describes copy-number distributions which are approximately centered at zero with relatively large, chromosome-invariant widths. (b) A Plot 3030 of the 248th probelet may describe the corresponding variation across the patients. Copy numbers in this probelet may correlate with the date of hybridization of the normal blood samples, 4.18.2007, 7.22.2009, or other, with the P-values <10⁻³ (see the Table in FIG. 35 and FIG. 32). (c) A raster display 3040 of the normal data set may show the correspondence between the normal blood profiles and the 250th probelet and normal arraylet.

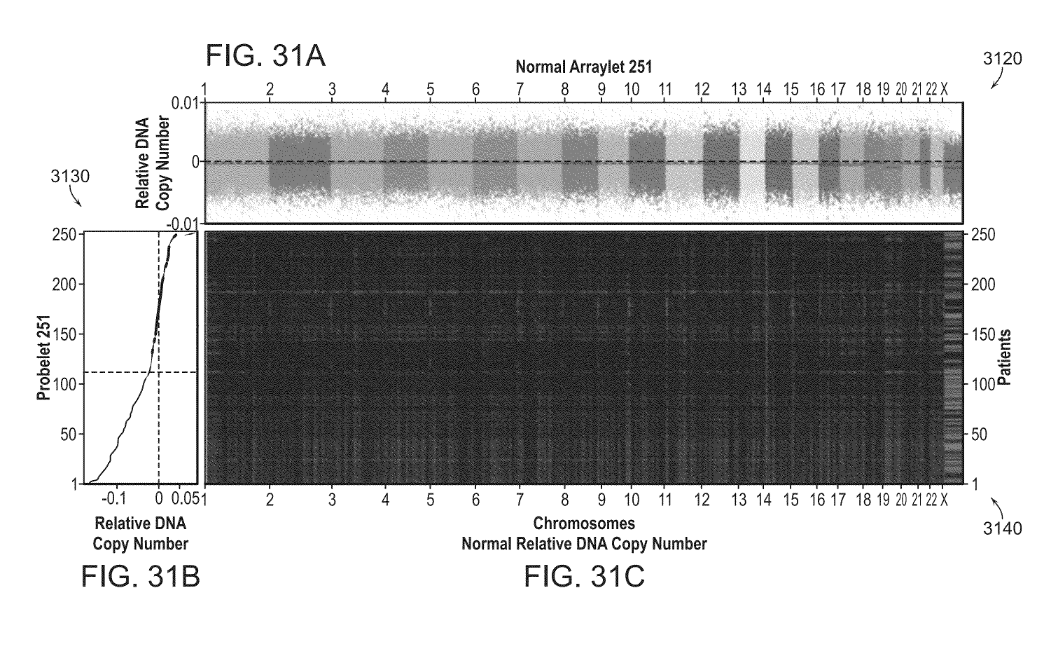

FIG. 31 is a diagram illustrating a first most normal-exclusive probelet and corresponding normal arraylet uncovered by GSVD, according to some embodiments. The normal-exclusive probelet is 251st, normal-exclusive probelet and the corresponding normal arraylet is uncovered by GSVD. (a) A Plot 3120 of the 251st normal arraylet describes unsegmented chromosomes (black lines), each with copy-number distributions which are approximately centered at zero with relatively large, chromosome-invariant widths. (b) A Plot 3130 Plot of the first most normal-exclusive probelet, which may also be the most significant probelet in the normal data set (see FIG. 22, 2240), describes the corresponding variation across the patients. Copy numbers in this probelet may significantly correlate with the genomic center where the normal blood samples were hybridized at, HMS, MSKCC, or multiple locations, with the P-values <10⁻¹³ (see the Table in FIG. 35 and FIG. 32). (c) A raster display 3140 of the normal data set may show the correspondence between the normal blood profiles and the 251st probelet and normal arraylet.

FIG. 32 is a diagram illustrating differences in copy numbers among the TCGA annotations associated with the significant probelets, according to some embodiments. Boxplot visualization of the distribution of copy numbers are shown of the (a) first, possibly the most tumor-exclusive probelet among the associated genomic centers where the GBM samples were hybridized at (Table in FIG. 35); (b) 247th, normal-exclusive probelet among the dates of hybridization of the normal blood samples; (c) 248th, normal-exclusive probelet between the associated tissue batches/hybridization scanners of the normal samples; (d) 249th, normal-exclusive probelet between the associated tissue batches/hybridization scanners of the normal samples; (e) 250th, normal-exclusive probelet among the dates of hybridization of the normal blood samples; (f) 251st, possibly the most normal-exclusive probelet among the associated genomic centers where the normal blood samples were hybridized at. The Mann-Whitney-Wilcoxon P-values correspond to the two annotations that may be associated with largest or smallest relative copy numbers in each probelet.

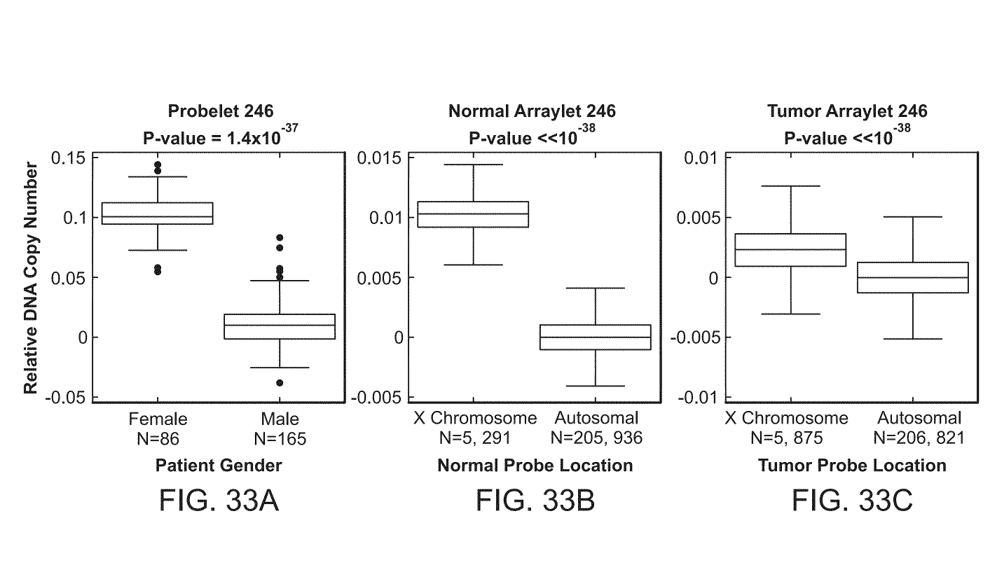

FIG. 33 is a diagram illustrating copy-number distributions of one of the probelet and the corresponding normal arraylet and tumor arraylet, according to some embodiments. Copy-number distributions relates to the 246th probelet and the corresponding 246th normal arraylet and 246th tumor arraylet. Boxplot visualization and Mann-Whitney-Wilcoxon P-values of the distribution of copy numbers are shown of the (a) 246th probelet, which may be approximately common to both the normal and tumor data sets, and may be the second most significant in the normal data set (see FIG. 22, 2240), between the gender annotations (Table in FIG. 35); (b) 246th normal arraylet between the autosomal and X chromosome normal probes; (c) 246th tumor arraylet between the autosomal and X chromosome tumor probes.

FIG. 34 is a table illustrating proportional hazard models of three sets of patients classified by GSVD, according to some embodiments. The Cox proportional hazard models of the three sets of patients are classified by GSVD, age at diagnosis or both. In each set of patients, the multivariate Cox proportional hazard ratios for GSVD and age may be similar and may not differ significantly from the corresponding univariate hazard ratios. This may indicate that GSVD and age are independent prognostic predictors.

FIG. 35 is a table illustrating enrichment of significant probelets in TCGA annotations, according to some embodiments. Probabilistic significance of the enrichment of the n patients, that may correspond to the largest or smallest relative copy numbers in each significant probelet, in the respective TCGA annotations are shown. The P-value of each enrichment can ne calculated assuming hypergeometric probability distribution of the K annotations among N=251 patients of the initial set, and of the subset of k⊂K annotations among the subset of n patients, as described by:

P(k,n,N,K)=(ₙ^{N})⁻¹Σ₁₋ₖⁿ(₁^{K})(ₙ₋₁^{N-K})

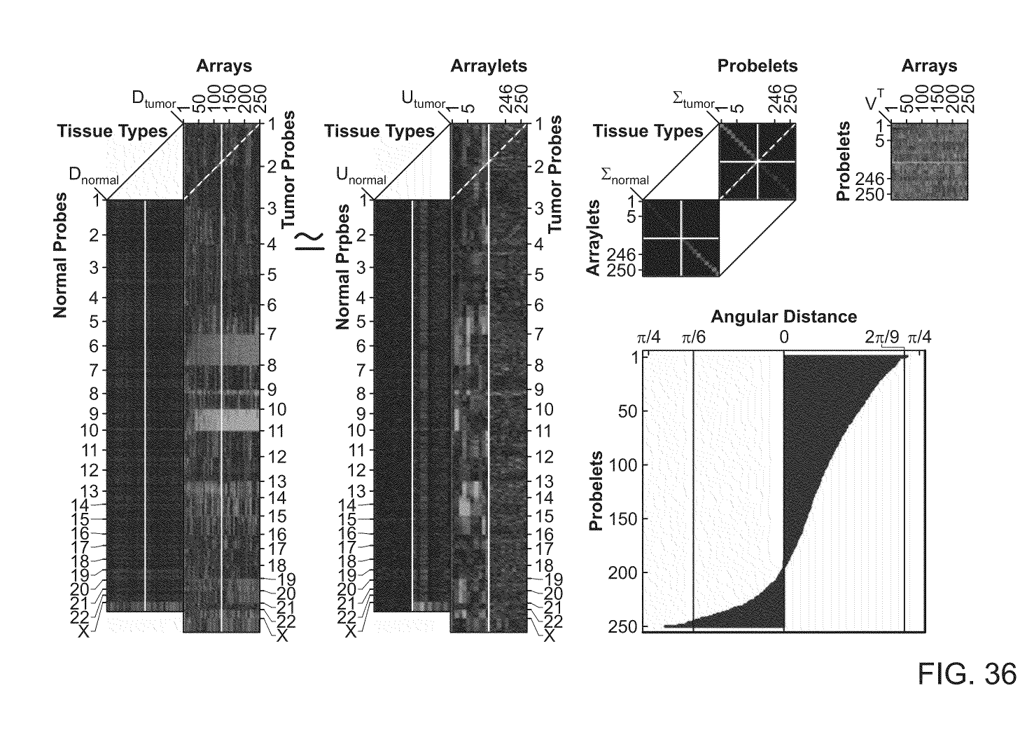

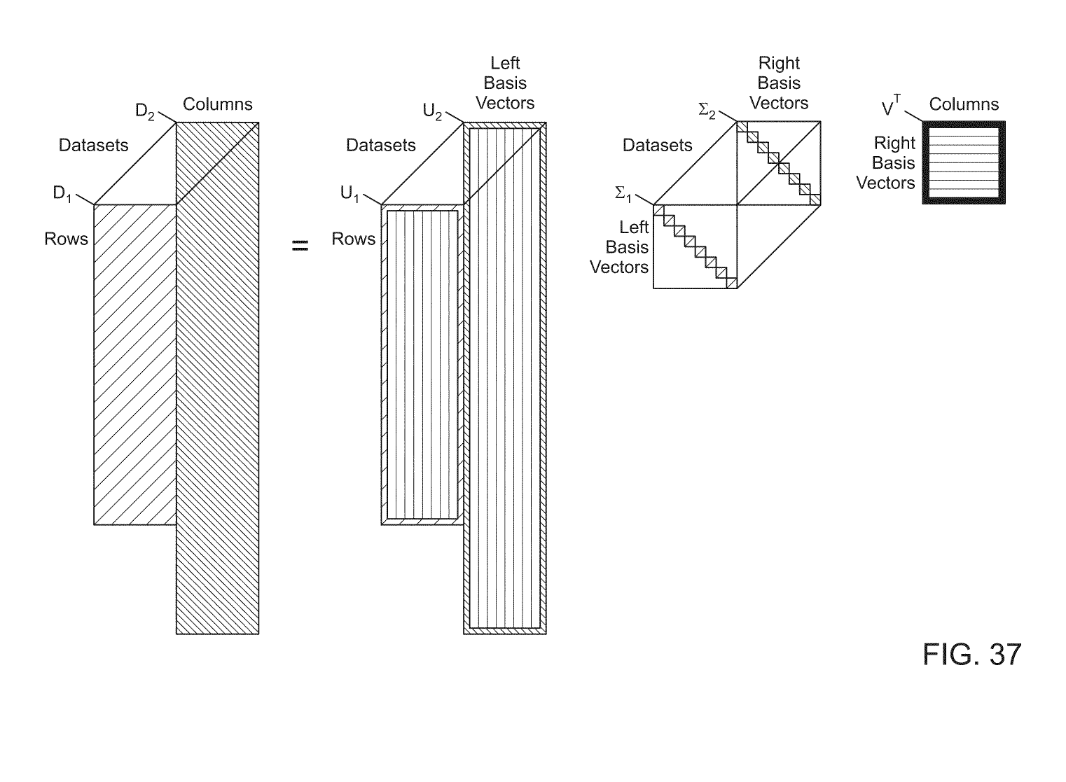

FIG. 36 is a diagram illustrating HO GSVD of biological data related to patient and normal samples, according to some embodiments. It shows the generalized singular value decomposition (GSVD) of the TCGA patient-matched tumor and normal aCGH profiles. The structure of the patient-matched but probe-independent tumor and normal datasets D_{I} and D₂, of the initial set of N=251 patients, i.e., N-arrays×M₁=212,696-tumor probes and M₂=211,227-normal probes, is of an order higher than that of a single matrix. The patients, the tumor and normal probes as well as the tissue types, each represent a degree of freedom. Unfolded into a single matrix, some of the degrees of freedom are lost and much of the information in the datasets might also be lost. The GSVD simultaneously separated the paired data sets into paired weighted sums of N outer products of two patterns each: one pattern of copy-number variation across the patients, i.e., a “probelet” νₙ^{T} (e.g., a row of right basis array), which is identical for both the tumor and normal data sets, combined with either the corresponding tumor-specific pattern of copy-number variation across the tumor probes, i.e., the “tumor arraylet” u_{1,n}, (e.g., vectors of array U₁ of left basis arrays) or the corresponding normal-specific pattern across the normal probes, i.e., the “normal arraylet” u_{2,n}, (e.g., vectors of array U₂ of left basis arrays). This can be depicted in a raster display, with relative copy-number gain, no change, and loss, explicitly showing the first though the 10th and the 242nd through the 251st probelets and corresponding tumor and normal arraylets, which may capture approximately 52% and 71% of the information in the tumor and normal data set, respectively.

The significance of the probelet νₙ^{T} (e.g., rows of right basis array) in the tumor data set (e.g., D₁ of the 3-D array) relative to its significance in the normal data set (e.g., D₂ of the 3-D array) is defined in terms of an “angular distance” that is proportional to the ratio of these weights, as shown in the following expression:

−π/4≦θ_{N}=arctan(σ_{1,n}/σ_{2,n})−π/4≦π/4.

This significance is depicted in a bar chart display, showing that the first and second probelets are almost exclusive to the tumor data set with angular distances >2π/9, the 247th to 251st probelets are approximately exclusive to the normal data set with angular distances <≈π6, and the 246th probelet is relatively common to the normal and tumor data sets with an angular distance >−π/6. It may be found and confirmed that the second most tumor-exclusive probelet, the most significant probelet in the tumor data set, significantly correlates with GBM prognosis. The corresponding tumor arraylet describes a global pattern of tumor-exclusive co-occurring CNAs, including most known GBM-associated changes in chromosome numbers and focal CNAs, as well as several previously unreported CNAs, including the biochemically putative drug target-encoding TLK2. It can also be found and validated that a negligible weight of the global pattern in a patient's GBM aCGH profile is indicative of a significantly longer GBM survival time. It was shown that the GSVD provides a mathematical framework for comparative modeling of DNA microarray data from two organisms. Recent experimental results verify a computationally predicted genomewide mode of regulation, and demonstrate that GSVD modeling of DNA microarray data can be used to correctly predict previously unknown cellular mechanisms. The GSVD comparative modeling of aCGH data from patient-matched tumor and normal samples draws a mathematical analogy between the prediction of cellular modes of regulation and the prognosis of cancers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

All publications and patents, and NCBI gene ID sequences cited in this disclosure are incorporated by reference in their entirety. To the extent the material incorporated by reference contradicts or is inconsistent with this specification, the specification will supersede any such material. The citation of any references herein is not an admission that such references are prior art to the present invention.

Those skilled in the art will recognize, or be able to ascertain using no more than routine experimentation, many equivalents to the specific embodiments of the invention described herein. Such equivalents are intended to be encompassed by the following embodiments.

What is claimed is:

1. A method, for medical characterization of a subject based on biological data, comprising:
applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B;
wherein the data comprises indicators, represented in respective rows and columns of the tensor, of values of at least two index parameters; and
determining an indicator of a health parameter of a subject, the determining based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.

2. The method of claim 1, further comprising outputting said indicator of health parameter along with a medical assessment.

3. The method of claim 1, wherein the index parameters comprise at least two of: patient identifications, tissue type identifications, a health status of one or more patients, a bioactive agent exposure status, an environmental exposure status, a nucleotide sequence copy numbers, DNA sequences, mRNA sequences, mRNA levels, a micro-RNA expression level, a DNA methylation level, a level of binding of proteins to DNA, a level of binding of proteins to RNA, gene product levels, gene product activity levels, a cell cycle status, a biochemical status, imaging data, a treatment status, biomarker levels, or time periods.

4. The method of claim 1, wherein the applying further comprises generating a diagonal matrix of singular values of each of A and B, and wherein the determining is further based on at least one of the diagonal matrices, wherein the singular values of A are the square roots of the eigenvalues of A^{T}A.

5. The method of claim 1, wherein the eigenvectors of A^{T}A are the same as the eigenvectors of B^{T}B.

6. The method of claim 1, wherein the determining occurs at a first time, and further comprising repeating the determining at a second time to track a course of a health condition of the subject.

7. The method of claim 1, wherein at least one of the index parameters is measurable by at least one of a DNA microarray, DNA sequencing, a protein microarray, or mass spectrometry.

8. The method of claim 7, wherein the data comprises chromatin or histone modification, and wherein the data are derived from a patient-specific sample including at least one of a normal tissue, a disease-related tissue, or a culture of a patient's cell.

9. The method of claim 1, wherein the data comprises at least one of magnetic resonance imaging (MRI) data, electrocardiogram (ECG) data, electromyography (EMG) data, or electroencephalogram (EEG) data.

10. The method of claim 1, wherein the applying substantially removes from the data at least one of normal pattern copy number variations (CNVs) and an experimental variation.

11. The method of claim 1, wherein the algorithm decomposes the tensor according to at least one of a higher-order singular value decomposition (HOSVD), a higher-order generalized singular value decomposition (HO GSVD), a higher-order eigenvalue decomposition (HOEVD), or a parallel factor analysis (PARAFAC).

12. The method of claim 1, wherein the applying classifies the subject into a subgroup of patients based on at least patient-specific genomic data.

13. The method of claim 1, wherein the applying correlates an outcome of a therapeutic method and a genomic predictor in the data.

14. A system, for medical characterization of a subject based on biological data, comprising:
a processor configured to apply a decomposition algorithm to an Nth-order tensor representing data, wherein N≧2, to generate, from at least two submatrices A and B of the tensor, eigenvectors of each of AA^{T}, A^{T}A, BB^{T}, and B^{T}B;
wherein the data comprises indicators, represented in respective rows and columns of the tensor, of values of at least two index parameters; and
an analysis module configured to determine an indicator of a health parameter of a subject, based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.

15. The system of claim 14, wherein the processor is further configured to generate a diagonal matrix of singular values of each of submatrices A and B, and wherein the analysis module is further configured to determine the indicator of the health parameter based on at least one of the diagonal matrices, wherein the singular values of A are the square roots of the eigenvalues of A^{T}A.

16. The system of claim 14, wherein the analysis module is further configured to determine the indicator of the health parameter at a first time, and to repeat the determination at a second time to track a course of a health condition of the subject.

17. The system of claim 14, wherein the processor is further configured to substantially remove from the data at least one of normal pattern copy number variations (CNVs) and an experimental variation.

18. The system of claim 14, wherein the processor is further configured to apply the decomposition algorithm to decompose the tensor according to at least one of a higher-order singular value decomposition (HOSVD), a higher-order generalized singular value decomposition (HO GSVD), a higher-order eigenvalue decomposition (HOEVD), or a parallel factor analysis (PARAFAC).

19. The system of claim 14, wherein the processor is further configured to apply the decomposition algorithm to classify the subject into a subgroup of patients based on at least patient-specific genomic data.

20. A non-transitory machine-readable medium comprising instructions that, when executed by one or more processors, perform the following acts:
applying a decomposition algorithm, by a processor, to an Nth-order tensor representing data, wherein N≧2, to generate, from at least two submatrices A and B of the tensor, eigenvectors of each of AA^{T}, A^{T}A, BB^{T}, and B^{T}B;
wherein the data comprises indicators, represented in respective rows and columns of the tensor, of values of at least two index parameters; and
determining an indicator of a health parameter of a subject, the determining based on the eigenvectors and on values, associated with the subject, of the at least two index parameters;
wherein the health parameter comprises at least one of a differential diagnosis, a first health status of the subject, a disease subtype, at least one of an estimated probability or an estimated risk of a second health status of the subject, an indicator of a prognosis of the subject, or a predicted response to a treatment of the subject.
